(19) United States
(12) Patent Application Publication
(10) Pub. No.: US 2020/0302348 A1
(43) Pub. Date: Sep. 24, 2020

(54) METHOD AND APPARATUS FOR DESCRIBING AND PROFILING EMPLOYEE SCHEDULES

(71) Applicant: ASPECT SOFTWARE INC., WESTFORD, MA (US)

(72) Inventors: DAVID RAWLE, HENDERSONVILLE, TN (US); AARON BESHEARS, FRANKLIN, TN (US)

(21) Appl. No.: 16/883,143

(22) Filed: May 26, 2020

Related U.S. Application Data
(63) Continuation of application No. 12/167,409, filed on Jul. 3, 2008.

(51) Int. Cl. G06Q 10/06

(52) U.S. Cl. CPC G06Q 10/06; G06Q 10/0631; G06Q 10/063

(57) ABSTRACT

A method and apparatus are provided for identifying activities within a work schedule. The methods include the steps of identifying an agent, defining at least one schedule profile associated with a single workday of the agent and identifying any occurrences within the work schedule that match the defined schedule profile.

### CROSS-REFERENCE TO RELATED APPLICATIONS

This application claims the benefit of priority as a continuation patent application of U.S. patent application Ser. No. 12/167,409 filed 3 Jul. 2008 entitled “Method and Apparatus for Describing and Profiling Employee Schedules”, the entire contents of which are incorporated herein by reference.

### FIELD OF THE INVENTION

The field of the invention relates to computer scheduling and more particularly to the scheduling of work forces.

### BACKGROUND OF THE INVENTION

The scheduling of work forces for many employment situations is a relatively simple task. Where the work schedule is known for months or years in advance, the task of scheduling may simply involve counting the number and types of workers needed and scheduling appropriately.

However, in other situations, the work load may vary rapidly from one day to the next and require a complex mixture of skills. One example of such a situation is in the telemarketing industry. In telemarketing, an organization may require hundreds or even thousands of agents to service the needs of the clients of the organization. The organization will usually provide a telephone and a computer to each agent and route contacts to the agents using an automatic contact distribution network.

If the organization is a merchant selling products, then the organization may need at least some agents qualified for each different product sold. If the products are complex, then the organization may also need agents qualified to answer questions about the product and how the product is to be used.

As the organization introduces new products or initiates promotional campaigns, then the agents qualified to service customer contacts in these areas may need to be increased proportionately. If the organization operates globally, then the agents may be required 24 hours a day, 7 days a week.

Moreover, many locales of employment (e.g., the Europe) have work rules that prescribe conditions of employment. For example, employees must periodically be given rest breaks. Other rules may prohibit working more than a predetermined number of hours in a day or some maximum number of contiguous days.

In the case of organizations with large numbers of employees, it is often difficult to ensure that work rules are followed while adequately servicing clients of the organization. Accordingly, a need exists for better methods of scheduling employees.

### SUMMARY

A method and apparatus are provided for identifying activities within a work schedule. The methods include the steps of identifying an agent, defining at least one schedule profile associated with a single workday of the agent and identifying any occurrences within the work schedule that match the defined schedule profile.

### BRIEF DESCRIPTION OF THE DRAWINGS

FIG. 1 is a block diagram of an automatic contact distribution system that uses an automatic scheduling system in accordance with illustrated embodiments of the invention;

FIG. 2 is a detailed block diagram of the scheduling system of FIG. 1;

FIG. 3 is an interactive window that depicts an access screen to the scheduling system of FIG. 1;

FIG. 4 is an interactive window that depicts an access screen for changing schedule profiles of the scheduling system of FIG. 1;

FIG. 5 is a window for selecting days of the week for schedule profiles used by the system of FIG. 1;

FIG. 6 is a window for selecting dates or a date range for schedule profiles used by the system of FIG. 1;

FIG. 7 is a window for entering days of a date range for schedule profiles used by the system of FIG. 1;

FIG. 8 is a window for attributes for schedule profiles used by the system of FIG. 1;

FIG. 9 is a window for entering a user's description of an attribute for schedule profiles used by the system of FIG. 1;

FIG. 10 is a window for describing schedule segments including detail segments, general segments, perspective states and superstates for schedule profiles used by the system of FIG. 1;

FIG. 11 is a window for selecting a time constraint for schedule profiles used by the system of FIG. 1;

FIG. 12 is a window for adding day constraints for schedule profiles used by the system of FIG. 1;

FIG. 13 is a window for configuring a work rule used by the system of FIG. 1;

FIG. 14 is a work rule editor window used by the system of FIG. 1;

FIG. 15 is a window for configuring work rules based on the maximum consecutive schedule profile plug-in used by the system of FIG. 1;

FIG. 16 is a window for configuring work rules based on the minimum consecutive schedule profile plug-in used by the system of FIG. 1;

FIG. 17 is a window for configuring a work rule based on the maximum schedule profile in window plug-in used by the system of FIG. 1;

FIG. 18 is a window for configuring a work rule based on the maximum schedule profile in window plug-in used by the system of FIG. 1;

FIG. 19 is a window for configuring a work rule based on the maximum working hours in window plug-in used by the system of FIG. 1;

FIG. 20 is a window for configuring a work rule based on the minimum working hours in window plug-in used by the system of FIG. 1;

FIG. 21 is a window for configuring a work rule based on the minimum time off plug-in used by the system of FIG. 1;

FIG. 22 is a window managing work rule sets used by the system of FIG. 1;

FIG. 23 is a window for adding or editing commands for a work rule used by the system of FIG. 1;

FIG. 24 is a work rules window used by the system of FIG. 1;

FIG. 25 is an employee supergroups window used by the system of FIG. 1;

FIG. 26 is a work rules window used by the system of FIG. 1;

FIG. 27 is a rule addition window used by the system of FIG. 1;

FIG. 28 is a reorder window used by the system of FIG. 1;

FIG. 29 is an equity rules window used by the system of FIG. 1;

FIG. 30 is an equity rule editor window used by the system of FIG. 1;

FIG. 31 is an equity rule set window used by the system of FIG. 1;

FIG. 32 is an equity rule set editor window used by the system of FIG. 1;

FIG. 33 is a further equity rule set window used by the system of FIG. 1;

FIG. 34 is an agent schedule used by the system of FIG. 1;

FIG. 35 is a multi-schedule assignment window used by the system of FIG. 1;

FIG. 36 shows an example of a structure of a schedule profile; and

FIG. 37 depicts schematically how duration, total time, and contiguous time are calculated for use with time constraints.

### DETAILED DESCRIPTION OF AN ILLUSTRATED EMBODIMENT

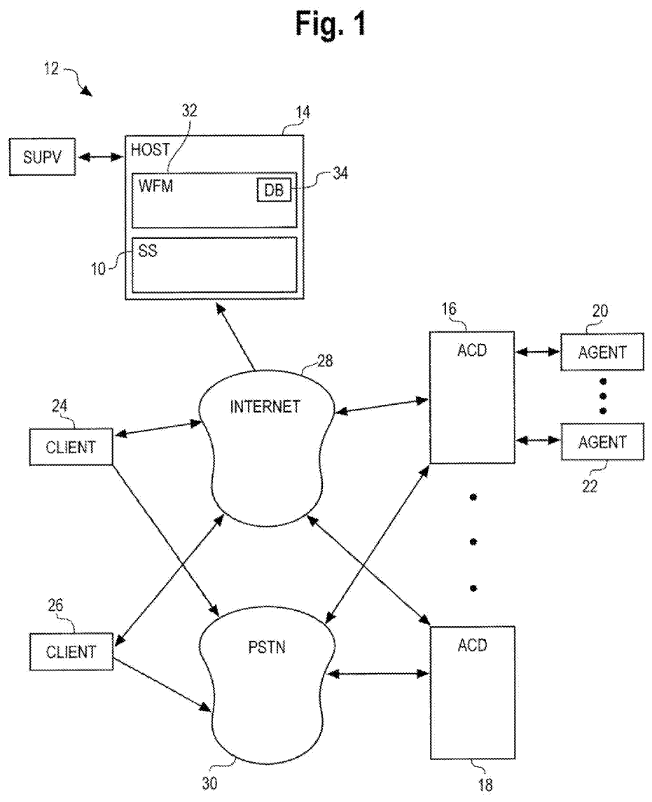

FIG. 1 is a block diagram of an automatic contact distribution system 12 with an automatic scheduling system 10 shown generally in accordance with an illustrated embodiment of the invention. The ACD system 12 of FIG. 1 may include a host 14 and a number of automatic contact distributors (ACDs) 16, 18. Associated with each of the ACDs 16, 18 may be a number of agents 20, 22.

In general, the ACD system 12 may be used by an organization to connect contacts initiated by clients 24, 26 with agents 20, 22 through the Internet 28 or PSTN 30 and one of the ACDs 16, 18. Alternatively, an ACD 16, 18 may initiate a contact with a client 24, 26. Once a client 24, 26 responds to the contact, the client 24, 26 may be connected to an agent 20, 22.

As contacts are detected, an ACD 16, 18 may collect contact associated information regarding each contact. In the case, of a call through the PSTN 30, contact associated information (e.g., ANI, DNIS, etc.) may be used to route the call. For example, an organization using the ACD system 12 may use a number of telephone numbers to receive inbound calls. Each telephone number may be reserved for a different product. As such, knowledge of the number called can be used as an indication of the purpose of the call.

Similarly, ANI information may be used to identify previous callers and clients and the purpose of previous calls. Together, DNIS and ANI may be used as a way to determine a probable purpose of the call and use the probable purpose for routing the call to the most qualified agent 20, 22.

Similarly, the organization may promulgate one or more e-mail addresses and/or chat rooms as a means of servicing clients 24, 26. As above, source and destination URLs of messages from clients 24, 26 may also be used to determine and to route contacts based upon the probable purpose of the contact.

The organization that uses the ACD system 12, may locate the respective ACDs 16, 18 near major metropolitan areas to better serve particular markets and to reduce telephony charges. Often the ACDs 16, 18 are located in different time zones.

Moreover, the organization that uses the ACD system 12 may handle any of a number of different products and/or services for its clients 24, 26. Accordingly, agents with a broad range of skills may be used to service client needs.

In cases, where the ACD system 12 requires large number of agents 20, 22, it is always necessary to have the proper number of agents with the proper skills located at the most accessible ACD 16, 18. The number of agents needed and mix of skills of those agents may be determined from statistical information collected from historical averages, from planned call campaigns and from sales and/or marketing projections.

Included within the system 12 may be a scheduling system 10 that functions to generate and provide scheduling information to agents 20, 22. The employee scheduling system 10 may be used within an automatic contact distribution (ACD) system 12 (as shown in FIG. 1) or within any of a number of other data processing systems.

The scheduling system 10 may be included within or be associated with a workforce management (WFM) server 32. The WFM server 32 may collect data regarding contacts handled by the ACD system 12 and save the collected data within a database 34. The data collected may include contacts per time period, the type of contacts and where the contacts were processed. The data collected by the WFM server 32 may be used to predict a future workload.

The scheduling system 10 may receive the predicted contact loading from the WFM server 32 and formulate one or more work schedules from the predicted workload. Work schedules are typically constructed as a multidimensional file existing within a computer system and accessible by employees as well as management. Along one dimension of a work schedule may be a series of fields that define the periods of the schedule (e.g., the days of the month). Along another dimension may be the agents scheduled for each day and/or number of work shifts in each workday. In some work schedules, the number of shifts may include only a single day shift (e.g., 8 am to 4:30 pm). In other schedules, the work schedule may include one or more evening schedules (e.g., a second shift scheduled between 4 pm to 12:30 am, a third shift scheduled from 12:00 am to 8 am, etc.).

Included within the scheduling system 10 may be an agent assignment processor 42 that sequentially or randomly selects agents 20, 22 and assigns the agents to work schedules 38, 40 based upon a number of control parameters. Control parameters associated with assignment of agents to the schedule may include predicted loading, agent skills, agent preferences, employment law and equity. The agent skill parameter may require a varying proportion of agents of each skill for each work period based upon the predicted loading for each skill provided by the WFM server 32.

Agent preferences may include a list of preferences of the agents 20, 22. Agent preferences may include a preference to work a day shift, a night shift, certain days of the week or even a preference to work a night shift or weekend shift for extra pay.

Employment law may include statutory requirements. For example, every two hours of work may require a 20 minute break or every four hours may require a one-half hour break.

Equity, in this case, may be established by the organization for purposes of employee morale. In this case, equity may require the equitable distribution of the number of night or weekend shifts or even the number of contiguous work days.

Because of the large number of often conflicting control parameters, prior attempts to perform automatic scheduling has been difficult and cumbersome. Often a great deal of manual intervention was required to achieve a balance among the parameters. Because of the large number of variables, a balance has not been possible.

In order to provide a flexible solution to the problem of scheduling, each of the schedules 38, 40 provided by the agent assignment processor 42 may be evaluated by a scheduling processor 36. The scheduling processor 36 uses a programmable set of rules to evaluate each work schedule 38, 40. Each equity rule includes a search plug-in and one or more schedule profiles. The rules may be either work rules or equity rules. In general, work rules and equity rules use the same structure and no differentiation is made herein between the two types of rules except where necessary to understand the use of each.

Turning, first, to rule plug-ins, rule plug-ins are COM objects (object oriented programs) that are installed and invoked as work rules from a rich client operating on a terminal of a supervisor or agent of the system 12. A single plug-in may be configured into a number of different work or equity rules depending upon the schedule profile used. For instance, a plug-in could be written to place a limit on the consecutive days of the week. The plug-in could be configured into one rule for consecutive Saturdays and another rule for consecutive Mondays.

Rule Plug-ins may be constructed in virtually any manner to provide a search function defined by one or more schedule profiles. Once constructed, a rule plug-in may require a certain low level of administration.

In general, a rule plug-in is configured to understand the context of the schedule assignment or schedule creation. The weeks prior and subsequent to the assignment/schedule run (i.e., a portion of a schedule 38, 40) may be considered in determining the validity of the rule built from the rule plug-in. Often the weeks subsequent to an agent assignment or schedule run will be empty (e.g., nothing scheduled for ensuing weeks of the following months); in this case, the rules will be evaluated based on no assigned schedules.

Following is a description of at least some exemplary rule plug-ins. While the exemplary plug-ins, together, are not inclusive of the needs for every situation, the plug-ins are directed to identifying a very useful set of scheduling events.

A first plug-in may be referred to as a Maximum Consecutive Schedule profile. This plug-in may be is used to prohibit an event described by a schedule profile from appearing too many times consecutively, relative to the days that the schedule profile is to be applied (defined in the day constraint of the schedule profile). This plug-in may be configured into a work rule by selecting a schedule profile and a number of times the schedule profile can appear consecutively.

Another plug-in may be referred to as a Minimum Consecutive Schedule profile. This rule plug-in is used to prohibit an event described by a schedule profile from not showing-up enough times consecutively, relative to the days that the schedule profile applies to (defined in the day constraint of the schedule profile). This plug-in may be configured into a work rule by selecting a schedule profile and a number of times the schedule profile must appear consecutively.

Another plug-in may be referred to as a Maximum Schedule Profile in Window. This rule plug-in is used to prohibit an event described by a schedule profile from showing-up too many times within some predefined window of time. This plug-in may be configured into a work rule by selecting a schedule profile, a number of times the schedule profile can appear within a window of time, and the parameters around the window of time. The window of time can either be a rolling window or a set of fixed windows (i.e. fiscal calendar).

Another plug-in may be referred to as a Minimum Schedule Profile in Window. This rule plug-in is used to prohibit an event described by a schedule profile from not showing-up enough times within a window of time. This plug-in may be configured into a work rule by selecting a schedule profile, a number of times the schedule profile can appear within a window of time, and the parameters around the window of time. The window of time can either be a rolling window or a set of fixed windows (i.e. fiscal calendar).

Another plug-in may be referred to as a Maximum Superstate Time in Window. This rule plug-in is used to prohibit the time an employee spends in a superstate (e.g., working) from being too large within a window of time. This plug-in may be configured into a work rule by selecting a superstate, a duration, and the parameters around the window of time. The window of time can either be a rolling window or a set of fixed windows (i.e. fiscal calendar). The term “superstate” is defined in more detail below.

Another plug-on may be referred to as a Minimum Superstate Time in Window. This rule plug-in is used to prohibit the time an employee spends in a superstate (e.g., working) from being too small within a window of time. This plug-in may be configured into a work rule by selecting a superstate, a duration, and the parameters around the window of time. The window of time can either be a rolling window or a set of fixed windows (i.e. fiscal calendar).

Another plug-on may be referred to as a Minimum Superstate Time Off After Schedule profile. This rule plug-in is used to force a superstate to be zero for a number of hours after a schedule profile occurs a number of times consecutively. This plug-in may be configured into a work rule by selecting a schedule profile, a number of occurrences, a superstate, and a duration.

The administration of rule plug-ins will consist of installing each rule plug-in COM object on at least some client work stations. For example, installation of rule plug-ins within agent stations may be necessary wherever it becomes necessary for agents to verify the validity of their schedules relative to a set of work-rules or to ensure the equitable distribution of certain types of schedules.

The concept of schedule profiles will be considered next. Schedule profiles are defined by one or more schedule event identifiers and are used to test if an agent's single day schedule is of a particular schedule type. Schedule profiles are designed to be a reusable means of defining schedule types for use within work rules and for ensuring schedule equity. They define constraints and conditions that can be tested against elements within an agent's schedule to identify nominal dates, activities and time spans that either match the profile or not. The results of this test may be used by agents to identify events or may be used by equity and work rules to determine an equity score for the agent, or to allow or reject an associated schedule 38, 40.

In general, schedule profiles have the following high level properties: 1) name; 2) description; 3) time zone; 4) day constraints and 5) conditions (grouped into attributes). The name and description attributes may be used for identification and selection of particular type of schedule profile. The time zone can be set to a fixed specific time zone or can be set to match the agent's time zone. Because an agent's time zone may be used, events within a schedule may or may not match a schedule profile based on where the time zone is defined. Day constraints are used to limit the nominal dates to which a profile applies. Testing a schedule with a schedule profile for a nominal date outside those defined by the day constraints results in “Not Applicable” for the profile.

There may be two different types of day constraints available: day(s) of week and date set. The days of week selection (or set) allows the user to allow matches to a schedule profile only for certain day(s) of the week. The day(s) of week selection is periodic by week.

The date selection (or set) constraint allows the user to allow matches to a schedule profile only for specific nominal dates.

Schedule attributes may be considered next. Schedule conditions (defined in more detail below) are grouped by schedule attributes. A schedule profile is considered a match only if all schedule attributes in the profile match. The profile joins the attributes with the Boolean AND operator.

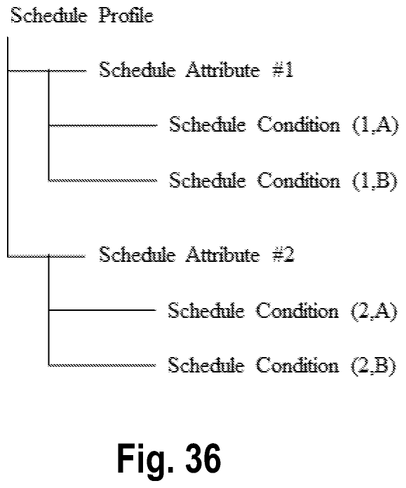

Within each schedule attribute is one or more schedule conditions. The schedule conditions define what event details the schedule must have in order to match. Schedule attributes match if any of its schedule conditions match. The conditions of schedule attributes are joined with the OR operator. FIG. 36 shows an example of the structure of a schedule profile.

In the example of FIG. 36, the profile matches may be defined with the following Boolean equation:

Schedule Profile=(Schedule Attribute #1) AND (Schedule Attribute #2)

Schedule Attribute #1=(Schedule Condition #1.A) OR (Schedule Condition #1.B)

Schedule Attribute #2=(Schedule Condition #2.A) OR (Schedule Condition #2.B)

Therefore

Schedule Profile=((Schedule Condition #1.A) OR (Schedule Condition #1.B)) AND ((Schedule Condition #2.A) OR (Schedule Condition #2.B)).

Schedule profiles also contain a negate schedule attribute flag. In this regard, the negate flag allows schedule attributes to use inverted logic when their negate flag is set to true. Each condition is evaluated and ORed together and then the result is negated. The result of negating an attribute is equivalent to inverting the result of each condition and joining the conditions with an AND operation.

For example,

Schedule Attribute=(Schedule Condition #1) OR (Schedule Condition #2)

NOT Schedule Attribute=(NOT Schedule Condition #1) AND (NOT Schedule Condition #2)

Conditions have the following properties: 1) Negation Flag; 2) Condition Type & Code Constraint; 3) Time Constraints and 4) Optional Day Constraints. With regard to the Negate Flag, schedule conditions use inverted logic when their respective negate flag is true. Such conditions are first filtered by any day constraints and then the schedule identification code and time constraints are evaluated and that result is inverted before being returned. Day constraints are not affected by the negation flag. The nominal dates for which the condition applies remains unchanged.

In general,

Condition=(Days) AND (Codes and Times)

Not Condition=(Days) and NOT(Codes and Times).

For example, the profile Working Christmas applies to December 25 with some schedule identification code and time constraints to determine whether the agent worked that day. Not Working Christmas would generally be interpreted as equivalent to Off Christmas. The negated profile still applies to the same date, but the logic of the code and time constraints are inverted for that date.

The Condition Type & Code Constraint determines the schedule identification code constraint used and the type of test performed using that code. Conditions can be of one of following types: 1) General Segment; 2) Detail Segment; 3) Perspective+State and 4) Super state. The term “segment” or “segment code” refers to the segment of workday. A general segment may mean the whole day. A detail segment may mean a work period, a lunch period or break period during the workday.

One simple example of Perspective+State is an agent listed within a schedule from the perspective of being paid while the +state may be defined by how much the agent gets paid from the perspective of being paid. Superstate may be defined as a union of perspectives and states.

The General Segment condition type uses either a single segment code or any segment code to test against the general segments of the schedule. If the user specifies a single segment code, then the condition is considered a match if there exists a general segment that has a matching code segment. If any segment code is selected, then the condition is considered a match if there exists a general segment in the schedule. General Segment conditions do not support time constraints.

The Detail Segment condition type also uses either a single segment code or any segment code to test against the detail segments of the schedule. If the user specifies a single segment code, then the condition is considered a match if there exists a detail segment that has a matching code and satisfies the time constraints. If any segment code is selected, then the condition is considered a match if within the aggregation of all the segments for a day, there exists a detail segment in the schedule that satisfies the time constraints.

The Perspective+State condition type performs a schedule resolution in the specified perspective and then tests the resolved schedule against either a single state or any non-default state. If there is a match for the state code(s) that meets the time constraints, the condition is considered a match. In the context of an ACD, the perspective may be an agent assigned to work in a certain agent group and the state may be working or not working.

The superstate condition type tests the schedule over some extended time period against the superstate definition to see if the agent is in the superstate within the time constraints. If the agent is in the superstate within the time constraints, the condition is considered a match.

The user has the option to select to use superstate summary data. This choice only supports time constraints on total time.

Time constraints define the time within a nominal date a match can occur. Codes that would otherwise match within the time constraints, when appearing outside the time range specified by the time constraints will not match.

Time constraints may have the following characteristics: 1) earliest start; 2) latest start; 3) earliest stop; 4) latest stop; 5) minimum span; 6) maximum span; 7) minimum total time; 8) maximum total time; 9) minimum contiguous time and 11) maximum contiguous time. All time characteristics are optional. If all time characteristics are omitted, the condition has no time constraints and can match any time of day for any duration.

The earliest start constraint establishes the earliest time on the nominal date a matching segment/state/superstate can start. For a schedule's segment/state/superstate to match the condition, its start time must be equal to or later than the earliest start. Since a nominal date could span longer than 24 hours, this attribute will include a flag to set which portion of the nominal date is intended: 2 days before, the day before, the same day (default), the day after, 2 days after.

The latest start constraint establishes the latest time on the nominal date a matching segment/state/superstate can start. For a schedule's segment/state/superstate to match the condition, its start time must be equal or earlier than the latest start. Since a nominal date could span longer than 24 hours, this attribute will include a flag to set which portion of the nominal date is intended: 2 days before, the day before, the same day (default), the day after, 2 days after.

The earliest stop constraint establishes the earliest time on the nominal date a matching segment/state/superstate can stop. For a schedule's segment/state/superstate to match the condition, its stop time must be equal or later than the earliest stop. Since a nominal date could span longer than 24 hours, this attribute will include a flag to set which portion of the nominal date is intended: 2 days before, the day before, the same day (default), the day after, 2 days after.

The latest stop constraint establishes the latest time on the nominal date a matching segment/state/superstate can stop. For a schedule's segment/state/superstate to match the condition, its stop time must be equal or earlier than the latest stop. Since a nominal date could span longer than 24 hours, this attribute will include a flag to indicate which portion of the nominal date is intended: 2 days before, the day before, the same day (default), the day after, 2 days after.

The minimum span constraint establishes the minimum time span required for matching segments/states/superstates. This is calculated by the difference between the latest matching stop time and the earliest matching start time of the schedule's match to this condition. This difference must be equal or greater than the minimum span for the condition to match.

The maximum span constraint establishes the maximum time span allowed for matching segments/states/superstates. This is calculated by the difference between the latest matching stop time and the earliest matching start time of the schedule's match to this condition. This difference must be equal to or less than the maximum span for the condition to match.

The minimum total time constraint establishes the minimum required total time covered by matching segments/states/superstates. This is calculated by adding the spans of all disjoint segments or states matching this condition. The total time must be equal or greater than the minimum total for the condition to match.

The maximum total time constraint establishes the maximum allowed total time associated with any matching segments or states. This is calculated by adding the spans of all times associated with all disjointed segments or states matching this condition. The total time must be equal or less than the maximum total for the condition to match.

The minimum contiguous time constraint establishes the minimum time any contiguous matching segment/state/superstate is allowed to span. This is calculated by finding the smallest matching contiguous segment or state and calculating its time span. This span must be equal or greater than the minimum contiguous time to avoid a match.

The maximum contiguous time constraint establishes the maximum time any contiguous matching segment/state/superstate is allowed to span. This is calculated by finding the largest matching contiguous segment or state and calculating its time span. This span must be equal or less than the minimum contiguous time to avoid a match.

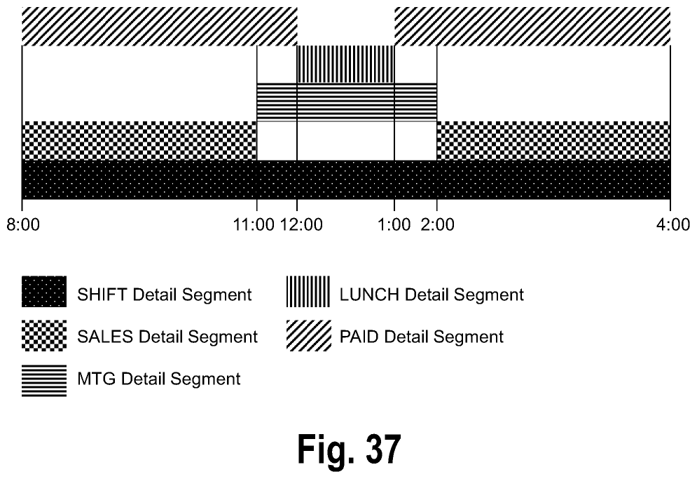

An example set of time span calculations is now provided. This example (FIG. 37) demonstrates how duration, total time, and contiguous time are calculated for use with time constraints.

Shown below is a Table I that shows the time calculations for the example of FIG. 37.

TABLE I

| | | | | | Minimum | Maximum |
|---|---|---|---|---|---|---|
| Segment | | | | Total | Contiguous | Contiguous |
| or State | Start | Stop | Span | Time | Time | Time |
| SHIFT | 8:00 | 4:00 | 8 Hours | 8 Hours | 8 Hours | 8 Hours |
| SALES | 8:00 | 4:00 | 8 Hours | 5 Hours | 2 Hours | 3 Hours |
| MTG(segment | 11:00 | 1:00 | 3 Hours | 3 Hours | 3 Hours | 3 Hours |
| code) | | | | | | |
| LUNCH | 12:00 | 1:00 | 1 Hour | 1 Hour | 1 Hour | 1 Hours |
| MTG | 11:00 | 1:00 | 3 Hours | 2 Hours | 1 Hour | 1 Hour |
| (perspective + | | | | | | |
| state, not in | | | | | | |
| graphic) | | | | | | |
| PAID | 8:00 | 4:00 | 8 Hours | 7 Hours | 3 Hours | 4 Hours |

In this example, the results of six schedule profiles are shown in the six rows from top to bottom. In the first four rows, the conditions include segment codes for shift, sales, meeting and lunch. The fifth row is in the context of a state plus perspective. The sixth row shows a superstate. As can be seen in this example, the results are more meaningful for MTG, if it were tested using Perspective+State rather than segment code.

Optional day constraints will be considered next. Attribute conditions can have day constraints similar to the day constraints of a schedule profile. The day constraints of a condition are independent of the profile's day constraints, but since the condition will only be evaluated for nominal dates matching the profile's day constraints, the sets of dates for a profile and its condition must have a non-empty intersection for the condition to ever be matched. The administrator creating schedule profiles may be required to ensure that day constraints at the profile and condition levels are consistent and sensible.

Day constraints for conditions may be one of the following: 1) none (default); 2) date set; 3) or day of week set. The meanings of the condition day constraints may be the same as the profile day constraints with no exception. The default day constraint “None” means the condition is evaluated for all days matching the profile's day constraints. If the condition has a day constraint other than None the condition is evaluated only for nominal dates that match the condition's day constraints and the profile's day constraints. If the day constraints are not satisfied, the condition evaluates to false.

A schedule profile logic Table II is shown below. This example illustrates the evaluation logic for schedule profiles. An asterisk means the value in that cell does not impact the result. In this table Conditions 1 and 2 belong to Attribute 1. Attribute 2 takes on an arbitrary value.

TABLE II

| | | | Negate | | | |
|---|---|---|---|---|---|---|
| | | | Attribute | | | |
| | Profile | | 1 (User | | | |
| Profile | Day | Attribute 1 | Supplied | Condition 1 | Condition 2 | Attribute 2 |
| Result | Constraints | Results | Flag) | Results | Results | Results |
| N/A | False | * | * | * | * | * |
| False | True | * | * | * | * | False |
| True | True | True | False | True | True | True |
| True | True | True | False | True | False | True |
| True | True | True | False | False | True | True |
| False | True | False | False | False | False | True |
| True | True | True | False | True | N/A | True |
| False | True | False | False | False | N/A | True |
| False | True | True | True | True | True | True |
| True | True | False | False | N/A | N/A | True |
| False | True | False | True | True | True | True |
| False | True | False | True | True | False | True |
| False | True | False | True | False | True | True |
| True | True | True | True | False | False | True |
| False | True | False | True | True | N/A | True |
| True | True | True | True | False | N/A | True |
| False | True | False | True | N/A | N/A | True |

Work rules may be considered next. Governments and unions impose work restrictions on organizations; these take the form of work rules and are used to restrict the schedules given to an employee. In addition to relying upon employee preferences, unavailable hours, and skills, the scheduling processor uses work rules to limit which schedules to give to an employee. Work rules consider the potential schedules for an employee in the context of existing schedules the employee is already scheduled to work. Work rules will be defined by selecting a rule plug-in and then providing that rule plug-in with its required information in the form of one or more schedule profiles. Different rule plug-ins will require different types of configuration.

Work rules may be named and collected into sets. A work rule set is defined by associating an employee group with a work rule and specifying a priority; the work rule is applied to all employees in the selected employee group and all of the child employee groups. Work rule sets may also be named and used when performing automatic assignment and preference based scheduling performed by the scheduling processor 36. Both automatic assignment and preference based scheduling rely upon the entire set of available schedules, filter out unacceptable schedules (based on work rules and other constraints) and score the remaining schedules based on preferences, skills, and, in the case of preference based scheduling, coverage.

Scoring may be used to select the more desirable schedule. If work rule scores among work schedules are substantially equal, then a significant difference in equity scores between the two schedules may be used to select the more desired schedule.

A number of examples of work rules may be offered. A first example may be a Maximum Consecutive Schedule Profiles work rule. The Maximum Consecutive Schedule Profiles work rule may use a rule plug-in that limits the maximum number of times a schedule profile can appear consecutively. The required configuration for the Maximum Consecutive Schedule Profile work rule is an appropriate rule plug-in with a schedule profile and a maximum number of events. The consecutive days of single day schedules that satisfy the schedule profile will be limited by this maximum number.

A more specific example may include a work rule that limits agents to a maximum of 3 consecutive night shifts. Suppose that a night shift is a schedule on any day of the week that starts after 5 pm and before 1 am. A night shift schedule profile may be defined that has a day constraint of any day and a defined profile condition that matches if the start time is between 5 pm and 1 am. This work rule may be defined by choosing the Maximum Consecutive Schedule Profiles rule plug-in, choosing the Night shift schedule profile and setting the maximum to 3. A schedule is valid relative to the work rule as long as there are no more than three days that satisfy the night shift schedule profile in a row.

Suppose the schedule of Table III, where a Off is a day with no segments (not satisfying the Night Shift schedule profile), Day is a day with segments starting before 5 pm (not satisfying the Night Shift schedule profile), and Night is a day with segments starting between 5 pm and 1 am (satisfying the Night Shift schedule profile).

TABLE III

| Sat | Sun | Mon | Tue | Wed | Thu | Fri |
|---|---|---|---|---|---|---|
| OFF | DAY | NIGHT | NIGHT | NIGHT | OFF | DAY |

The week of Table V is valid since the employee only works three single day schedules that satisfy the night shift schedule profile in a row. Relative to the Night Shift schedule profile of Table III, the work rule would provide an output as shown in Table IV.

TABLE IV

| Sat | Sun | Mon | Tue | Wed | Thu | Fri |
|---|---|---|---|---|---|---|
| FALSE | FALSE | TRUE | TRUE | TRUE | FALSE | FALSE |

In the example of Table IV, true indicates a match and false indicates no match.

Now, suppose schedule of Table V where Off, Day and Night are defined as above.

TABLE V

| Sat | Sun | Mon | Tue | Wed | Thu | Fri |
|---|---|---|---|---|---|---|
| OFF | NIGHT | NIGHT | NIGHT | NIGHT | OFF | DAY |

The week is invalid since the employee has four single day schedules that satisfy the night shift schedule profile in a row. When the night shift schedule profile rule is applied to the schedule of Table V, the results is as shown in Table VI.

TABLE VI

| Sat | Sun | Mon | Tue | Wed | Thu | Fri |
|---|---|---|---|---|---|---|
| FALSE | TRUE | TRUE | TRUE | TRUE | FALSE | FALSE |

As shown in Table VI, the rule returns a match.

Now suppose that a weekend shift is defined to be a Saturday or a Sunday schedule with positive paid hours. A user would define a weekend shift schedule profile that has a day constraint of Saturday or Sunday and also a defined condition that matches if there are positive hours in the paid superstate. The user would define this work rule by picking the Maximum Consecutive Schedule Profiles rule plug-in, choosing the Weekend Shift schedule profile and setting the maximum to 2. A schedule is valid relative to the work rule as long as there are no more than two consecutive schedules on Saturday or Sunday satisfying the weekend shift schedule profile. Because a schedule is classified as a weekend shift only if it is worked on Saturday or Sunday, the validity of this rule will be determined irrespective of the schedules on Monday through Friday.

Now suppose the three weeks of schedules of Table VII, where Off is a Saturday or Sunday with no segments (not satisfying the weekend shift schedule profile), and On is a Saturday or Sunday with positive hours in the paid superstate (satisfying the Weekend Shift schedule profile). Because the day constraint for the Weekend Shift schedule profile does not include Monday-Friday, the presence or absence of schedules on these days does not matter.

TABLE VII

| Sat | Sun | Mon | Tue | Wed | Thu | Fri |
|---|---|---|---|---|---|---|
| OFF | ON | | | | | |
| OFF | ON | | | | | |

In terms of the work rule (ignoring the days that are not part of the day constraint for the schedule profile), Table VIII shows the matches relative to the Weekend Shift schedule profile of Table VII.

TABLE VIII

| Sat | Sun | Sat | Sun | Sat | Sun |
|---|---|---|---|---|---|
| FALSE | TRUE | | TRUE | | TRUE |

These weeks are valid since the employee only works one single day schedule in a row that satisfies the weekend shift schedule profile.

Now suppose the three weeks of schedules of Table IX, where Off and On are defined as above.

TABLE IX

| Sat | Sun | Mon | Tue | Wed | Thu | Fri |
|---|---|---|---|---|---|---|
| ON | OFF | | | | | |
| ON | ON | | | | | |
| OFF | ON | | | | | |

In terms of the work rule (ignoring the days that are not part of the schedule profile), the work rule provides the output as shown in Table X.

TABLE X

| Sat | Sun | Sat | Sun | Sat | Sun |
|---|---|---|---|---|---|
| TRUE | | TRUE | TRUE | | TRUE |

These weeks are valid since the employee only works two single day schedules in a row that satisfy the Weekend Shift schedule profile.

Now suppose the following three weeks of schedules of Table XI, where Off and On are defined as above.

TABLE XI

| Sat | Sun | Mon | Tue | Wed | Thu | Fri |
|---|---|---|---|---|---|---|
| OFF | ON | | | | | |
| ON | ON | | | | | |
| OFF | ON | | | | | |

In terms of the work rule (ignoring the days that are not part of the schedule profile), the work rule provides the output shown in Table XII.

TABLE XII

| Sat | Sun | Sat | Sun | Sat | Sun |
|---|---|---|---|---|---|
| | TRUE | TRUE | TRUE | | TRUE |

These weeks are invalid under the work rule since the employee works three single day schedules in a row that satisfy the Weekend Shift schedule profile.

Now suppose the following three weeks of schedules as shown in Table XIII, where Off and On are defined as above.

TABLE XIII

| Sat | Sun | Mon | Tue | Wed | Thu | Fri |
|---|---|---|---|---|---|---|
| ON | OFF | | | | | |
| ON | ON | | | | | |
| ON | OFF | | | | | |

In terms of the work rule (ignoring the days that are not part of the schedule profile), the work rule provides the matches shown in Table XIV.

TABLE XIV

| Sat | Sun | Sat | Sun | Sat | Sun |
|---|---|---|---|---|---|
| TRUE | | TRUE | TRUE | TRUE | |

These weeks are invalid under the work rule since the employee works three single day schedules in a row that satisfy the Weekend Shift schedule profile.

Now suppose the assignment processor is assigning or creating schedules and there are no schedules assigned for subsequent weeks. The Saturday and Sunday in the subsequent week would not satisfy the Night Shift schedule profile. The following three weeks would be valid since no schedule is assigned on the Saturday after the weekend where she has to work both Saturday and Sunday.

TABLE XV

| Sat | Sun | Mon | Tue | Wed | Thu | Fri |
|---|---|---|---|---|---|---|
| ON | OFF | | | | | |
| ON | ON | | | | | |
| OFF | OFF | | | | | |

Now consider a Minimum Consecutive Schedule Profiles work rule. The Minimum Consecutive Schedule Profiles rule plug-in is used to define a work rule that requires the detection of a minimum number of event times consecutively. The Minimum Consecutive Schedule Profile rule plug-in requires an appropriate schedule profile and a minimum number. The consecutive days of single day schedules that satisfy the schedule profile will be limited by this minimum number. Described below are examples.

Suppose that a day off is a day with zero hours in the pay perspective. A Day Off schedule profile may be defined that has a day constraint of any day with a negated condition of positive paid superstate hours. This work rule may be defined by picking the Minimum Consecutive Schedule Profiles rule plug-in, the Day Off schedule profile and setting the maximum to 2. A schedule is valid relative to the work rule as long as days that satisfy the Days Off schedule profile happen in at least pairs.

Suppose the following week of schedules as shown in Table XVI, where Off is a schedule with no segments (satisfying the Day Off schedule profile). The week of Table XVI is valid since the employee is off both Monday and Tuesday.

TABLE XVI

| Sat | Sun | Mon | Tue | Wed | Thu | Fri |
|---|---|---|---|---|---|---|
| Not OFF | OFF | OFF | Not OFF | Not OFF | Not OFF | Not OFF |

Next, suppose the week of Table XVII. The week of Table XVII is invalid since the employee is off Sunday but works on Monday.

TABLE XVII

| Sat | Sun | Mon | Tue | Wed | Thu | Fri |
|---|---|---|---|---|---|---|
| Not OFF | OFF | Not OFF | Not OFF | OFF | OFF | Not OFF |

Another example may include a Minimum of 2 Consecutive Weekend Shifts Off. Suppose that a weekend shift is defined to be a Saturday or Sunday schedule with more than zero paid hours. A schedule is valid relative to the work rule as long as there are at least two weekend shifts off in a row without any scheduled hours. Because a schedule is classified as a weekend shift only if it is a Saturday or Sunday, the validity of this rule will be determined irrespective of the schedules on Monday through Friday. The following three weeks of Table XVIII are valid since the employee is off the Saturday and Sunday of the middle week.

TABLE XVIII

| Sat | Sun | Mon | Tue | Wed | Thu | Fri |
|---|---|---|---|---|---|---|
| Not OFF | Not OFF | | | | | |
| OFF | OFF | | | | | |
| Not OFF | Not OFF | | | | | |

The following three weeks of Table XIX are valid since the employee is off the Sunday of the first week and the Saturday and Sunday of the middle week.

TABLE XIX

| Sat | Sun | Mon | Tue | Wed | Thu | Fri |
|---|---|---|---|---|---|---|
| Not OFF | OFF | | | | | |
| OFF | OFF | | | | | |
| Not OFF | Not OFF | | | | | |

The following three weeks of Table XX are invalid since the employee is not off two consecutive Saturdays or Sundays.

TABLE XX

| Sat | Sun | Mon | Tue | Wed | Thu | Fri |
|---|---|---|---|---|---|---|
| OFF | Not OFF | | | | | |
| OFF | OFF | | | | | |
| OFF | Not OFF | | | | | |

Suppose the organization is assigning or creating schedules and there are no schedules assigned for subsequent weeks. The Saturday and Sunday in the subsequent week are considered to be off relative to the schedule profile since there is no schedule assigned. The following three weeks of Table XXI are would be valid since no schedule is assigned on the Saturday after the weekend where she is off on Sunday.

TABLE XXI

| Sat | Sun | Mon | Tue | Wed | Thu | Fri |
|---|---|---|---|---|---|---|
| Not OFF | Not OFF | | | | | |
| Not OFF | OFF | | | | | |
| OFF | OFF | | | | | |

In another example, consider a Maximum Number of Schedule Profiles in Window work rule. The Maximum Number of Schedule Profiles in Window rule plug-in is used to define a work rule that limits the number of times a schedule profile can appear within a window of time. Below is an example.

In this example, a maximum of 3 night shifts every 7 days is required. Suppose that a night shift is a schedule on any day of the week that starts after 5 pm and before 1 am. The organization could define a night shift schedule profile that has a day constraint of any day and define a schedule profile condition that matches schedule events if the start time is between 5 pm and 1 am. The organization would define this work rule by picking the Maximum Number of Schedule Profiles in Window rule plug-in, choosing the night shift schedule profile, set the rolling window to be 7 days and setting the maximum value to 3. A schedule is valid relative to the work rule as long as there are no more than three days that satisfy the night shift schedule profile within any 7 day window.

Suppose the organization has the following week of schedules shown in Table XXII, where a Off is a day with no segments (not satisfying the night shift schedule profile), Day is a day with segments starting before 5 pm (not satisfying the night shift schedule profile), and Night is a day with segments starting between 5 pm and 1 am (satisfying the Night Shift schedule profile):

TABLE XXII

| Sat | Sun | Mon | Tue | Wed | Thu | Fri |
|---|---|---|---|---|---|---|
| OFF | DAY | NIGHT | NIGHT | NIGHT | OFF | DAY |
| OFF | DAY | NIGHT | NIGHT | NIGHT | OFF | DAY |
| OFF | DAY | NIGHT | NIGHT | NIGHT | OFF | DAY |

The weeks of Table XXIII are valid since the employee only works three night shifts in any 7 days.

The following three weeks of Table XXIII are invalid since the employee works four night shifts in the 7 days starting on Tuesday.

TABLE XXIII

| Sat | Sun | Mon | Tue | Wed | Thu | Fri |
|---|---|---|---|---|---|---|
| OFF | DAY | DAY | NIGHT | NIGHT | NIGHT | OFF |
| OFF | DAY | NIGHT | NIGHT | NIGHT | OFF | DAY |
| DAY | NIGHT | NIGHT | NIGHT | OFF | DAY | OFF |

Next consider a Minimum Number of Schedule Profiles in Window work rule. The Minimum Number of Schedule Profiles in Window rule plug-in is used to define a work rule that requires a particular schedule profile to be used a minimum number of times within a window of time of the work schedule. Below is an example.

In this example, a minimum 10 day shifts in a month work rule is used. Suppose that a day shift is a schedule on any day of the week that starts after 6 am and before 5 pm. The organization may define a day shift schedule profile with a day constraint of any day and define a schedule profile condition that matches if the start time is between 6 am and 5 pm. The organization may define this work rule by picking the Minimum Number of Schedule Profiles in Window rule plug-in, choosing the night shift schedule profile, setting the minimum to 10 and setting the window to be the months in the standard calendar. A schedule is valid relative to the work rule as long as there are at least 10 schedules that match the day shift schedule profile in the month.

Suppose the organization has the following week of schedules as shown in Table XXIV, where a Off is a day with no segments (not satisfying the Night Shift schedule profile), Day is a day with segments starting before 5 pm (not satisfying the Night Shift schedule profile), and Night is a day with segments starting between 5 pm and 1 am (satisfying the Night Shift schedule profile):

A schedule is valid relative to the work rule as long as within any month there are at least 10 day shifts. The following month of Table XXIV (beginning on Sunday and ending on Tuesday) is valid since the employee works more than 10 schedules that satisfy the day shift schedule profile during the month.

TABLE XXIV

| Sat | Sun | Mon | Tue | Wed | Thu | Fri |
|---|---|---|---|---|---|---|
| OFF | DAY | DAY | NIGHT | NIGHT | OFF | DAY |
| OFF | DAY | DAY | NIGHT | NIGHT | OFF | DAY |
| OFF | DAY | DAY | NIGHT | NIGHT | OFF | DAY |
| OFF | DAY | DAY | NIGHT | NIGHT | OFF | DAY |
| OFF | DAY | NIGHT | | | | |

Table XXV shows an example of a schedule that would be invalid under the Minimum 10 day shifts in a Month rule.

TABLE XXV

| Sat | Sun | Mon | Tue | Wed | Thu | Fri |
|---|---|---|---|---|---|---|
| OFF | DAY | DAY | NIGHT | NIGHT | OFF | DAY |
| OFF | DAY | DAY | NIGHT | NIGHT | OFF | DAY |
| OFF | OFF | OFF | OFF | OFF | OFF | OFF |
| OFF | OFF | OFF | OFF | OFF | OFF | OFF |
| OFF | OFF | OFF | | | | |

A Maximum Superstate Time in Window rule may be considered next. The Maximum Hours in Window rule plug-in is used to define a work rule that limits the amount of time that a particular superstate can appear within a window.

A Minimum Superstate Time in Window may also be created. The Minimum Hours in Window rule plug-in is used to define a work rule that forces a number of hours for a particular superstate within a window to be below some predetermined minimum.

A Minimum Superstate Time Off after Schedule Profile work rule may also be created. The Minimum Hours after Schedule Profile rule plug-in is used to define a work rule that forces a superstate to be zero for a number of hours after a schedule profile has found a match for a predetermined number of times.

As an example, a Minimum 18 Hours Off after Two Night Shifts work rule may be created. Suppose that the organization has defined a night shift schedule profile that has a day constraint of any day and defines a condition that matches if the start time is between 5 pm and 1 am. The organization may also have a superstate defined that indicates that the employee is working.

Suppose the organization now has the following week of schedules of Table XXVI where Off and Night are defined as above.

TABLE XXVI

| Sat | Sun | Mon | Tue | Wed | Thu | Fri |
|---|---|---|---|---|---|---|
| OFF | NIGHT | NIGHT | OFF | OFF | OFF | OFF |

The goal is for this work rule is to prevent positive superstate hours (for the specified superstate) after the second night shift ends. The organization may define the second night shift as ending either when the superstate goes to zero for segments in the nominal date, or at midnight of the nominal date if the superstate is zero for the segments in the nominal date.

Work rule scoring may be considered next. Each rule plug-in will return a result that helps the assignment algorithm or the preference based scheduling algorithm used by the schedule processor 36 determine what schedule to assign or create, respectively. The rule plug-in will return the current state of the rule, i.e. whether or not the rule is true. The rule will also return a value that is used to measure the likelihood that the rule will be satisfied as additional schedules are assigned or created. The goal of the score to help the assignment and preference based scheduling algorithms know how the acceptability (i.e. the likelihood of not violating the work rule) of one schedule verses the other schedules. For the rule plug-ins that have a schedule profile as a parameter, the score that it returns from the work rule must be done in a way that is agnostic to the definition of the schedule profiles that are used. To accomplish this, the logic of the rule plug-in assumes that for each unassigned day that it is possible for the day to either pass the schedule profile or fail the schedule profile, and that either option is equally likely. The evaluation of days either matching or not matching schedule profiles includes days within the assignment run or preference based schedule run as well as the days beyond the run. The evaluation of matched or not matched schedule profiles are used to generate the score.

For the rule plug-ins that use superstate hours, the rule plug-in will need some guidance for the likelihood of satisfying the work rule. This is provided in the configuration of the work rule in terms of an average number of hours per day that assigned schedules will contribute to the superstate; the work rule may also be configured so that the rule plug-in can account for the variability of superstate hours in schedules.

Equity rules will be considered next. An equity rule is a single measure of fairness of schedule assignment. An equity rule is an accounting mechanism that can be generated for a set of employees and used to judge how fairly a particular schedule type has been distributed across the set of agents.

It its simplest form, an equity rule may be defined as a pairing of a schedule profile and a window of time to count the occurrences over. In a more practical form, an equity rule may be defined by pairing a schedule profile with a rule plug-in that counts the occurrences of some event over the window of time where the event and window are defined by the schedule profile. Equity rules may be implemented as part of an equity rule set. The equity rule set may be administered from within the scheduling system 10. The configuration of an equity rule set will consist of a name and description along with a prioritization of Equity Rules. A user may choose to use an equity rule set when assigning schedule or generating schedules in preference based scheduling.

The scheduling system 10 may also generate an equity report. The organization may also allow users (agents) to view a report that shows the calculation for the equity score. The user will select: a set of employees; one or more equity rules and a date. The report calculates the equity score (i.e. the count of the schedule profile within the window of time) for each employee and equity rule.

Preference based scheduling will be described next. In this regard, an administrative user has the option of selecting a work rule set prior to creating one or more schedules. To account for work rules, preference based schedule may be modified to check the viability of schedules against each of the work rules in a selected work rule set.

Prior to assigning a schedule to an employee or employees, all possible schedules will be evaluated against the rules in the work rule set. For a given rule and schedule, there are four possibilities. First, assigning this schedule will not violate a work rule and it will prevent the work rule from being violated with additional assignments. Second, assigning this schedule will not violate a work rule but additional assignments may violate the work rule. Third, assigning this schedule will violate a work rule but additional assignments may allow the rule to not be violated. In this case, the work rule is not satisfied.

Forth, assigning this schedule will violate a work rule and additional assignment will also violate the work rule. This would be a work rule violation.

During schedule generation, the schedule generating module 36 may assign a schedule that will cause a work rule to not be satisfied. However, it will not assign a schedule that will cause a work rule violation. If all possible schedules cause a work rule violation, then that employee will not be assigned any additional schedules. The assignment result for the employee determined by the assignment system 10 (and message generated for the benefit of the user will be “Schedules cannot be assigned for Agent X without violating work rule.”

In general, the agent assignment processor 42 may generate a number of possible work schedules. The scheduling processor 36 may apply a set of work rules to identify those schedules most likely to comply with the applicable work rules. Work schedules that do not comply with the applicable work rules may be discarded. The agent assignment processor 42 may then amend the remaining schedules by adding more scheduling events (e.g., scheduled agents) and the process may repeat.

In an attempt to equalize certain types of schedules, the scheduling system user may also be given the option of selecting one of a number of equity rule sets for execution by the scheduling processor 36 between iterations. To improve the equity score for employees, the flow of preference based scheduling may be modified by the user so that before other schedules are created, employees with low Equity Scores will have schedules created that improve their Equity Score.

Under one illustrated embodiment, the multi-schedule assignment program module either assigns schedules to meet minimum hours goal for employees (and then continues with additional assignment past minimum) or it assigns schedules based on a projected target number of hours for each employee. Under another illustrated embodiment, if the user chooses to balance schedules based on an equity set of rules, then a multi-schedule module 62 may be used to pre-empt these processes by creating another set of equity improving schedules to employees with low equity scores.

The multi-schedule module may be interrupted by a number of additional options. These options in a first case may include the situation that a work rule not satisfied. This will cause assignment of agents to the schedule to stop if at any time a work rule is not satisfied.

Alternatively, the multi-schedule module may be interrupted if a work rule not satisfied for an employee. This will cause assignment to stop if, at the end of assigning schedules to an employee, a work rule is not satisfied.

Alternatively, the multi-schedule module may be interrupted if the module cannot assign without work rule violation. This will cause assignment to stop if no schedules can be assigned to an employee without violating a work rule.

Alternatively, the multi-schedule module may be interrupted if there is no improvement in equity in successively generated schedules for employees with low equity scores. This will cause assignment to stop if there is an employee with one of the lowest equity scores who cannot be assigned a schedule that would help his equity score.

At the end of the scheduling run, the user is presented with the schedule results for each employee, as well as what assignments were made. For each employee, the user is presented with the following information about the number of schedules that were assigned: 1) no schedules assigned; 2) minimum hours not met; 3) assigned minimum hours; 4) assigned schedules past minimum hours; 5) number days not met and 6) assigned number of days.

For each employee, the system 10 will also proved information about why more schedules were not assigned to the employee. The information may be include indicators as follows: 1) employee has not been hired; 2) employee is terminated; 3) employee has no preferences; 4) no schedules to assign; 5) preferences already satisfied by schedules; 6) currently assigned to employee; 7) schedules conflict with employee's available times (employee preferences); 8) schedules conflict with employee's forced days off (official general segments); 9) schedules conflict with employee's preferences; 10) schedules (based on staff group) conflict with employee's skills; 11) schedules cannot be assigned without violating work rule and 12) schedules cannot be assigned without violating scheduling runtime constraint.

If there is a Work Rule Set being used for the assignment run, work rule information will be presented to the user. The work rule information may include: 1) no work rule violations or 2) work rule not satisfied. If the result is “Work rule not satisfied”, then the user reviews any presented information to evaluate why that is the case. One possibility is that it would be possible to satisfy the work rule if there were more/different schedules available during the assignment run. Another possibility is that this rule cannot be satisfied until assignments are made on subsequent weeks.

If there is an equity rule set being used for the assignment run, there will be information about which agents had their equity score improve. The agents with improved equity scores are listed within an equity score list.

Automatic Assignment is performed by choosing an appropriate menu option in an assignment worksheet menu. The user selects the schedule he/she wants to assign and then selects the assignment type (e.g., Multi-schedule Assignment, Single Schedule Assignment, or Personal Account Assignment).

The runtime screen for Automatic Assignment allows the user to specify the work rule set and equity rule set to be used for the assignment run. It also has additional stopping options available that will stop the assignment process if there are work rule violations or if there is not sufficient improvement in the Equity Scores for employees. The assignment results include details about the schedules that were assigned as well as information about why more schedules were not assigned to the employee. Additionally, the assignment results give indication as to how the equity score for employees was affected by the assignment run. Multi-schedule Assignment considers single day schedules and assigns multiple schedules (if possible) to an employee.

To account for work rules, the multi-schedule assignment module or scheduling module checks the viability of schedules against a selected work rule set. Prior to assigning a schedule to an employee, all unassigned schedules are evaluated against the rules in the work rule set. For a given rule and schedule, there are four possibilities (as set forth above).

Single schedule assignment considers multi-day schedules and assigns a single schedule (if possible) to employees. To account for work rules, single schedule assignment checks the viability of schedules against a selected Work Rule Set. Prior to assigning schedules to an employee, all unassigned schedules are evaluated against the rules in the work rule set.

A single schedule assignment module assigns schedules based on the order specified by the user. If the user chooses to balance schedules based on an equity rule set, then the single schedule assignment module will pre-empt this process by assigning equity improving schedules to employees with low equity scores.

Additional stopping conditions may be added for Single Schedule Assignment. These options may first include the situation where a work rule is not satisfied. This will cause assignment to stop if at any time a work rule is not satisfied.

Another stopping condition may result from the work rule not satisfied for an employee. This will cause assignment to stop if, at the end of assigning schedules to an employee, a work rule is not satisfied.

Another stopping condition may occur when the assignment module cannot assign without work rule violation. This will cause assignment to stop if no schedules can be assigned to an employee without violating a work rule.

Another stopping condition occurs when so improvement in equity occurs for employees with low equity scores. This will cause assignment to stop if there is an employee with one of the lowest equity scores who cannot be assigned a schedule that would help his equity score.

At the end of the assignment run, the user is presented with the results for each employee, as well as what assignments were made. For each employee, the user will see a summary of information about the number of schedules that were assigned.

Agents may also be allowed to request personal account assignments. Personal account assignment considers sets of single day schedules to assign to an employee. To account for work rules, personal account assignment checks the viability of schedules against a selected Work Rule Set.

Prior to assigning schedules to an employee, all unassigned schedules will be evaluated against the rules in the Work Rule Set; for a given rule and schedules, there are four possibilities. One possibility is that assigning these schedules will not violate a work rule and it will prevent the work rule from being violated on assignment runs in the case of minimum requirements. The second possibility is that assigning these schedules will not violate a work rule but additional assignment runs may violate the work rule. The third possibility is that assigning these schedules will violate a work rule but additional assignment runs may allow the rule to not be violated. (Work rule not satisfied). The fourth possibility is that assigning these schedule will violate a work rule and additional assignment will not help satisfy the work rule. (Work rule violation).

During assignment, the assignment module may assign schedules that will cause a work rule to not be satisfied. However, it will not assign schedules that will cause a work rule violation. If all available schedules cause a work rule violation, then that employee will not be assigned any schedules. The assignment result for the employee will be a message presented to the user that schedules cannot be assigned without violating work rule.

To equalize certain types of schedules, the user may be given the option of selecting an equity rule set. To improve the equity score for employees, the flow of assignment of work to agents within the schedule may be interrupted so that before other schedules are assigned, employees with low Equity Scores will be assigned schedules that improve their Equity Score.

Additional stopping conditions may be provided for the personal account assignment. These options will include the situations discussed above.

At the end of the assignment run, the user is presented with the results for each employee, as well as what assignments were made. For each employee, the user is presented with a summary information about the number of schedules that were assigned as discussed above.

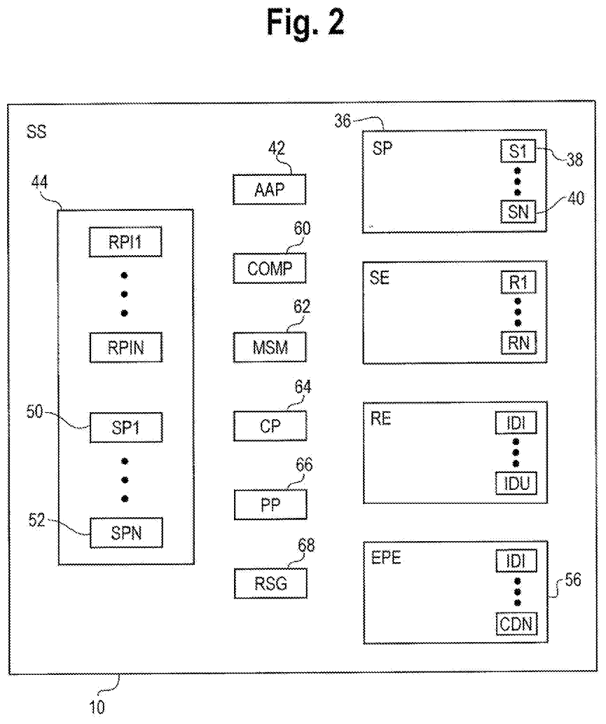

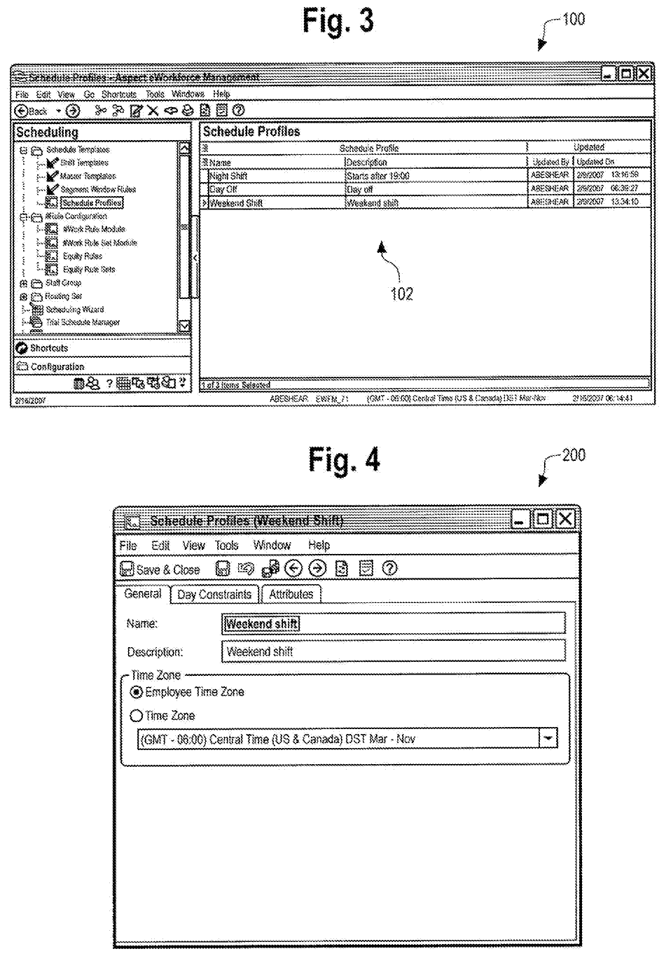

Schedule profiles are managed in the schedule profiles processor 36 (FIG. 2) located in the scheduling section 10. FIG. 3 depicts a schedule profile access window or webpage (hereinafter “window”) 100 that may be generated by the schedule processor 36. The schedule profile editor window 100 depicts a number of softkeys 102 for accessing any previously formed schedule profiles 50, 52 located within a memory 44. For example, activating the softkey labeled WEEKEND SHIFT takes the user to a schedule profile editor window 200 (FIG. 3). The editor window 200 allows the user to preform adding, editing, deleting, and duplicating of the schedule profiles 50, 52. The GENERAL softkey of the schedule profile editor 200 allows the user to set the code and description for the profile as well as define the time zone used to interpret time values when processing this profile.

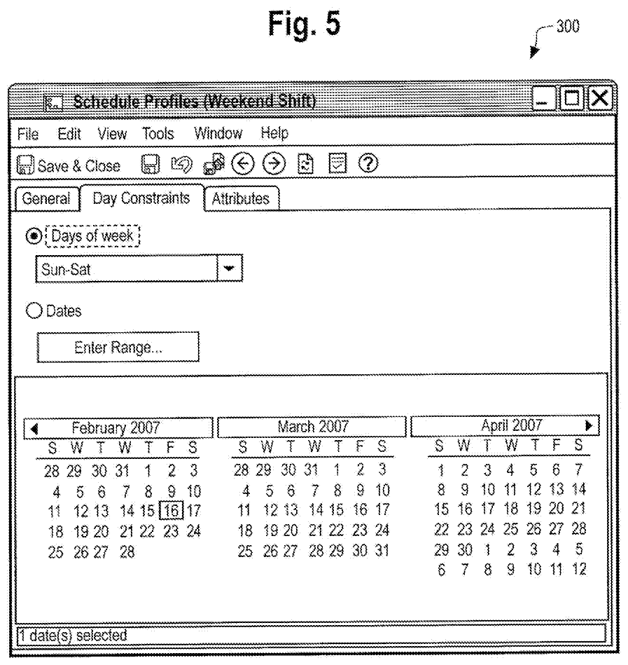

The day constraints for a schedule profile are chosen by activating a DAY CONSTRAINTS softkey on the schedule profile editor window 200, thereby opening the day constraints window 300 of FIG. 5. The day constraints window 300 controls the selection of the nominal dates that the schedule profile is intended to match. Any nominal dates not matching the profile's day constraints are dates for which the profile is considered not applicable. Dates that are not applicable do not count for or against consecutive occurrences of the given profile.

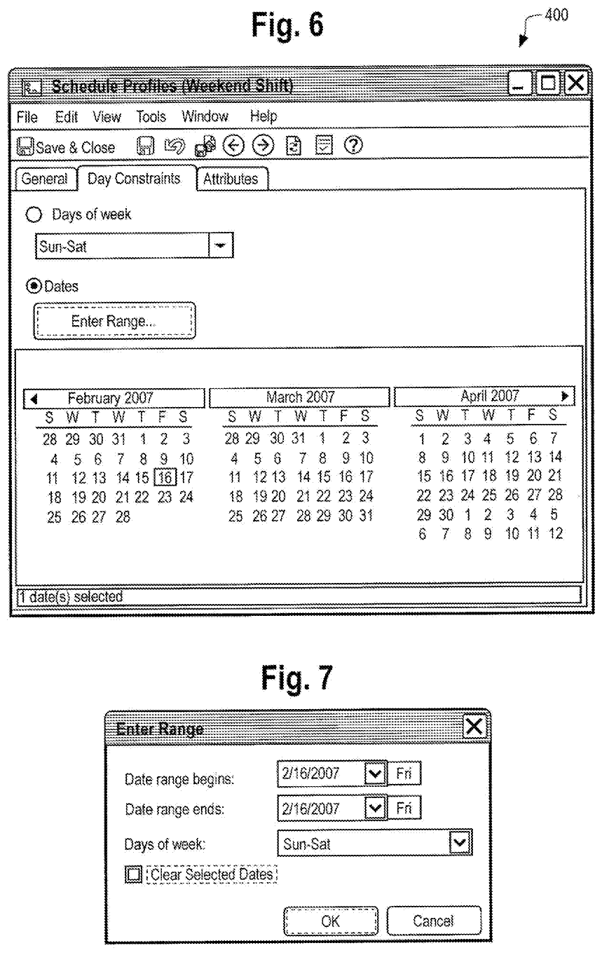

The day constraints of the schedule profile are configured by activating the softkey labeled DATES. Activating the DATES softkey allows selection of dates through the dates window 400 of FIG. 6.

There are two types of day constraints: Days of Week and Dates. If Days of Week is selected (FIG. 5), the schedule profile will only match schedules on the selected days of week shown below the check box. If Dates is selected, then the calendar control (FIG. 6) will be enabled. The user selects the desired dates (marked in bold) by double clicking the individual dates in the calendar. Note that the calendar indicates the total number of selected dates in the status bar.

By clicking the ENTER RANGE button, the user is taken to the enter range window of FIG. 7. On the enter range window, the user is able to add or remove a range of selected dates.

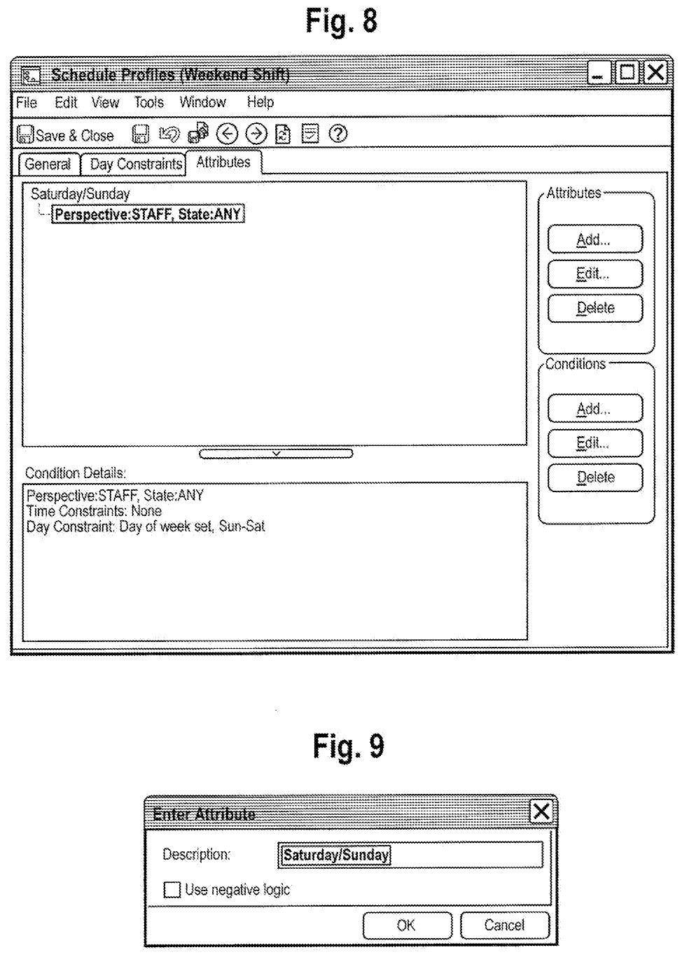

The user configures the attributes of the schedule profile by activating the ATTRIBUTES softkey on the window of FIGS. 4-6 and is taken to the attributes window of FIG. 8. On this window, the user is able to add, edit and delete the schedule profile attributes as well as the conditions associated with them.

The descriptions of the profile's attributes appear at the top level window with a summary of the condition shown as child nodes (bottom window). If the user selects a condition, the details of the condition are displayed on a condition window.

A schedule profile attribute is a collection of conditions along with a description. The description allows the user to comment on the intended logic of the attribute to aid in maintenance of the schedule profile. For example, if the user where to activate the ATTRIBUTE EDIT button of FIG. 8, the EDIT ATTRIBUTE window of FIG. 9 may be displayed. The user may also select the “USE NEGATIVE LOGIC” check box (FIG. 9) to invert the logic of the attribute.

The conditions of an attribute are configured using a condition editor. This allows the user to configure a condition that is tested against an agent's official or tentative schedule. There are three parts to this test: 1) Segment, state, and superstate codes; 2) Time constraints for the segments and 3) Day constraints. The condition editor window for a selected condition in the lower window of FIG. 8 may be opened by selecting the condition and then activating the CONDITION ADD or EDIT softkeys on FIG. 8.

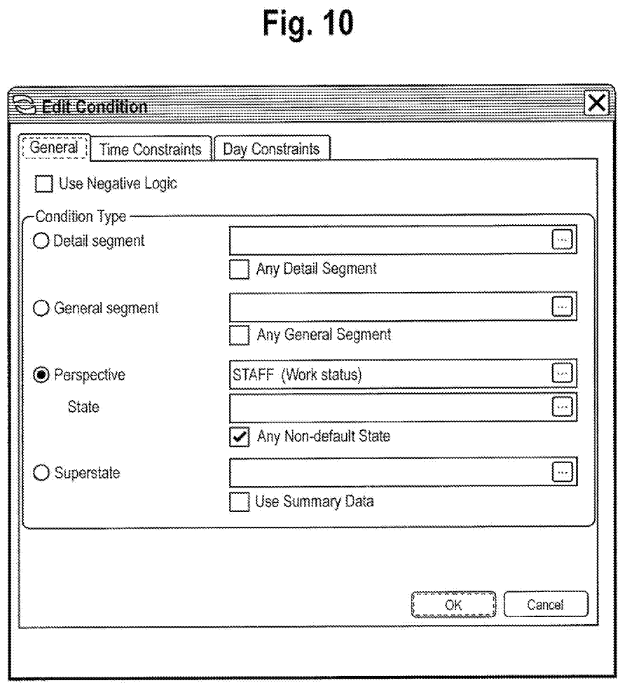

The GENERAL softkey of FIG. 8 take the user to the segment code window of FIG. 10 and allows the user to choose the segment code test for the condition as well as whether the condition should use negative logic. There are four different types of segment-related tests described below. The first may be a Detail Segment Condition Type code test. The detail segment condition tests the code of the detail segments of a single day schedule. The code can either be specific (as selected by the segment code item entry control), or it could match any code. For a specific code to match the condition, there must be a detail segment with the selected code that satisfies the time constraints. Matching any code simply requires that there exists a detail segment that satisfies the time constraints.

The second type of segment-related test is a General Segment Condition Type code test. The general segment condition tests the code of the general segments of a single day schedule. The code can either be specific (as selected by the segment code item entry control), or it could match any code. Matching any code simply requires that a general segment exists for a schedule regardless of its specific code. If General Segment is selected, no time constraint options will be available.

The third type of segment-related test is a Perspective+State Condition Type code test. The Perspective+State condition tests the resolution of a day schedule. The user selects a perspective for this resolution and either a specific state or any non-default state. For a specific state to match the condition, the time in the state must satisfy the time constraints. Matching any non-default state requires that the time in the non-default state satisfies the time constraints.

The fourth type of segment-related test is a Superstate Condition Type code test. The superstate condition tests a superstate resolution of a day schedule. The user has the option of whether or not to use superstate summary data or to perform superstate resolution. If the user selects to do a resolution, then the superstate will match if it satisfies all of the time constraints. If summary data is used, then the superstate will match if it satisfies the duration time constraint.

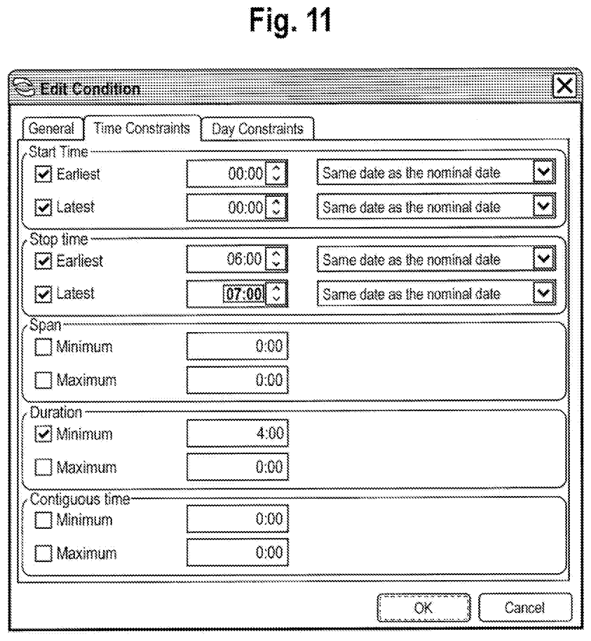

The user may also activate the TIME CONSTRAINTS softkey of FIG. 10 and be taken to the time constraints window of FIG. 11. The time constraints softkey is used to specify the time constraints for the condition if the condition type is Detail, Perspective+State, or Superstate. The time constraints for a condition are a set of optional constraints for the start, stop, span, duration and contiguous time. For the start and stop times, the time may be placed on the given nominal date or up to two days earlier or later than the nominal date.

The start time may be further defined in terms of earliest start and latest start. The earliest start constraint requires that the segment/state/superstate start no earlier than the earliest start time. The latest start constraint requires that the segment/state/superstate start no later than the latest start time.

The stop time may be further defined in terms of earliest stop and latest stop. The earliest stop constraint requires that the segment/state/superstate ends no earlier than the earliest stop time. The latest stop constraint requires that the segment/state/superstate ends no later than the latest stop time.

The span may be further defined in terms of minimum and maximum spans. The minimum span constraint requires that the difference between the latest time and the earliest time of the segment/state/superstate is at least as long as the duration given. There may be gaps in this time where the segment/state/superstate is not used.

The maximum span constraint requires that the difference between the latest time and earliest time of the segment/state/superstate is no longer than the duration given. There may be gaps in this time where the segment/state/superstate is not used. The maximum span must be greater than or equal to the minimum span (if set).

The duration may be further defined in terms of minimum and maximum times. The minimum total time constraint requires that the total time of the specified segment/state/superstate is at least as long as the duration given. The maximum total time constraint requires that the total time of the specified segment/state/superstate is no longer than the duration given. The maximum total time must be greater or equal to the minimum total time (if set).

The contiguous time may be further defined in terms of minimum and maximum times. The minimum contiguous time constraint requires that for all contiguous spans of time of the specified segment/state/superstate, each span of time is at least as long as the duration given. The maximum contiguous time constraint requires that for all contiguous spans of time of the specified segment/state/superstate, each span of time is not greater than the duration given.

These constraints may be used in any combination, apart from the minimum and maximum relationships described, no other validation is done to ensure the time constraints are reasonable.

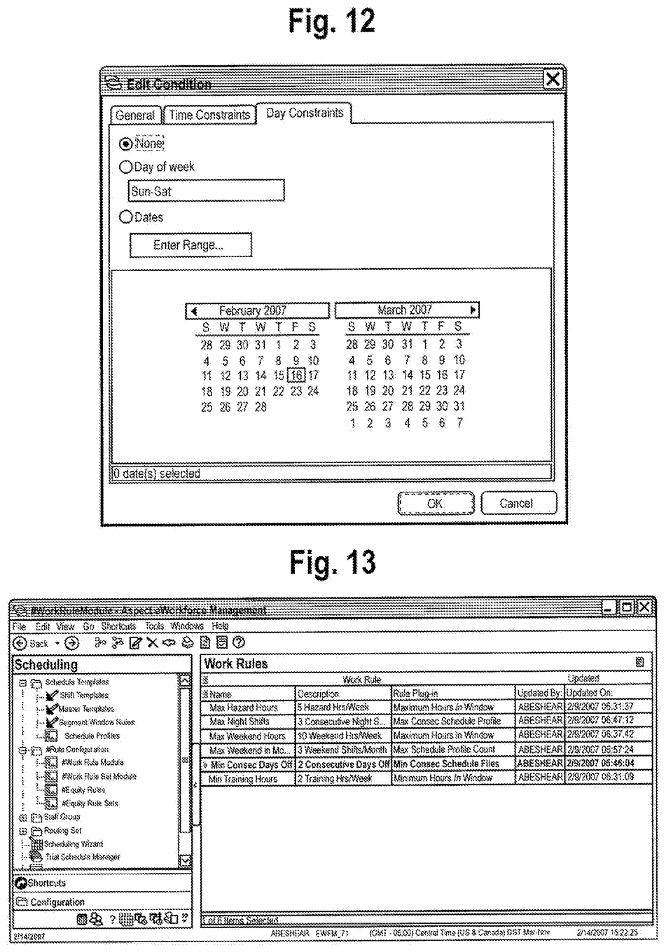

The day constrains window of FIG. 12 may be reached by activating the DAY CONSTRAINTS softkey of FIG. 10. Conditions may include day constraints similar to the profile. Conditions are only evaluated when a schedule's nominal date matches the profile's day constraints. This means that unless the day constraints of the condition and profile match some dates in common, the condition will never match.

Work rules are managed in the work rules module 52 located in the scheduling system 10. A work rule editor window of FIG. 13 may be accessed by activating the WORK RULE MODULE softkey shown in FIG. 3.

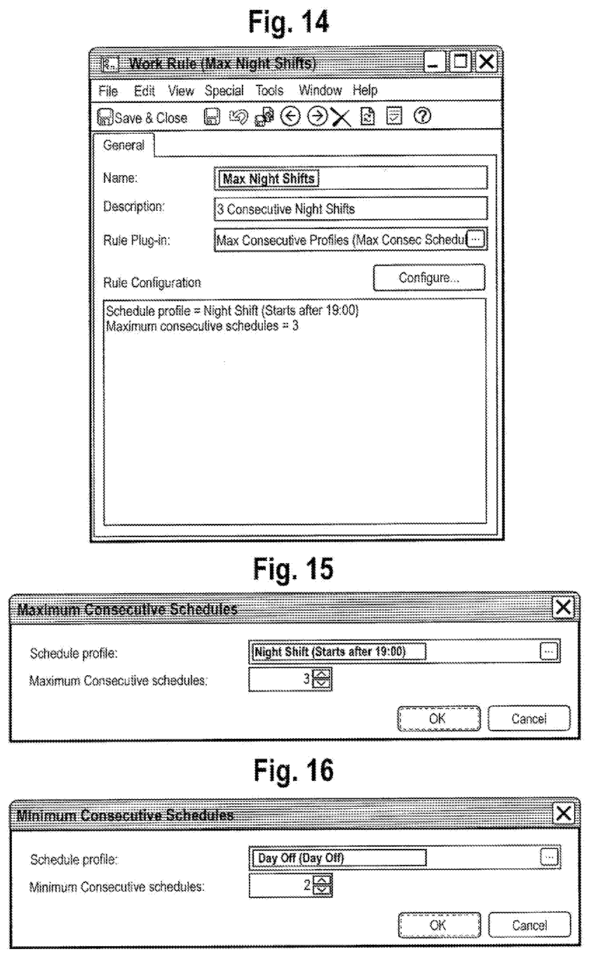

The user may select a work rule from the menu shown in FIG. 13. The user may then select the Add or Edit softkey for a work rule on a work rule window to open the work rule editor for the selected work rule (FIG. 14).

All work rules have a name and a description. The type of rule is selected using the plug-in item entry control; this value can only be changed when adding a new work rule. Once a rule plug-in has been selected from the menu window, the user may configure the rule by clicking the “Configure” button. The configure button opens a form specific to the plug-in selected. The current configuration for the work rule is displayed as localized text in the read only memo. The text for this box is localized and composed by the plug-in. If the user attempts to save the work rule without defining any configuration for it, the user will be presented with a warning and have the option of canceling the save command.

The Maximum Consecutive Schedule Configuration window of FIG. 15 may be activated by selecting the maximum consecutive schedule configuration line in the menu of FIG. 14. This window is used to configure a work rule based on the maximum consecutive schedules plug-in.

The Maximum consecutive schedule profiles window of FIG. 15 is activated by selecting the maximum consecutive schedules profiles plug-in from the menu of FIG. 14. This rule requires a schedule profile and a non-negative integer as parameters. (A value of 0 prevents that schedule profile from appearing.) The rule will generate localized configuration of the form:
Schedule profile=Night Shift(Starts after 19:00)
Maximum consecutive schedules=3

The Minimum Consecutive Schedule Configuration window of FIG. 16 is activated by selecting the minimum consecutive schedules profiles plug-in from the menu of FIG. 14. This window is used to configure a work rule based on the minimum consecutive schedules plug-in. This rule requires a schedule profile and a positive integer as parameters.

The rule will generate localized configuration of the form:
Schedule profile=Day Off(Day Off)
Maximum consecutive schedules=2

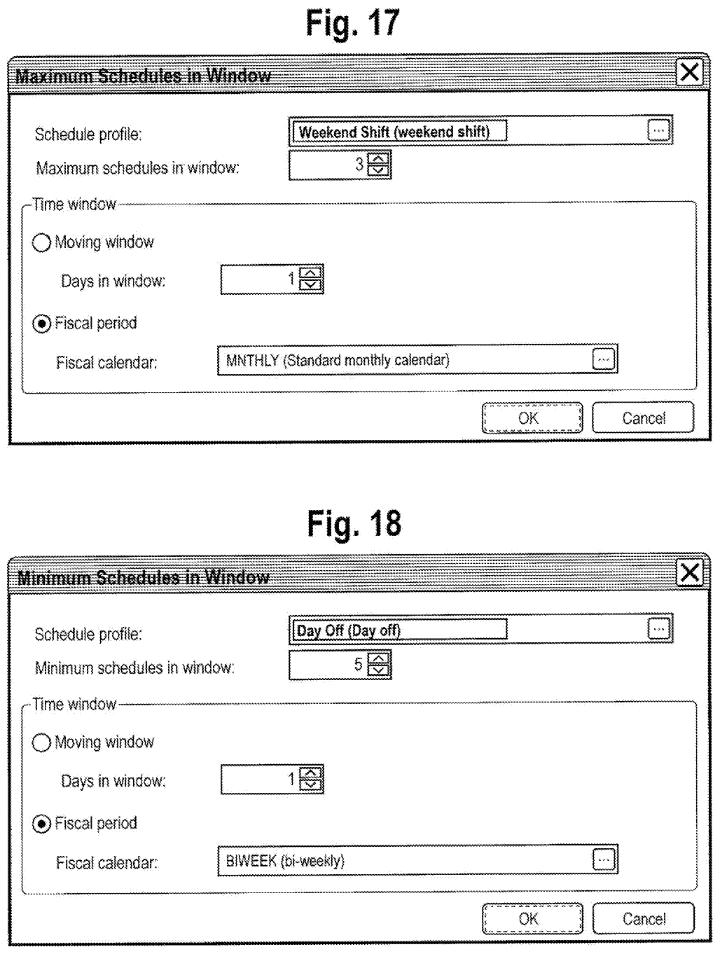

The Maximum Schedule Profile in Window Configuration window of FIG. 17 is activated by selecting the maximum schedule profile in window plug-in from the menu of FIG. 14. This window is used to configure a work rule based on the maximum schedule profiles in window plug-in.

This rule requires a schedule profile, a non-negative integer, and a definition for the time window. The time window may be described in one of two ways. First, when moving window is selected, all contiguous spans of the specified number of days that include the evaluating schedule are tested against the maximum occurrences of the given profile. Second, when fiscal period is selected, the entire fiscal period that contains the evaluating schedule is tested against the maximum occurrences of the given profile.

The rule will generate localized configuration of the form:
Schedule profile=Weekend Shift(Weekend shift)
Minimum schedules in window=3
Fiscal period=MNTHLY(Standard monthly calendar) The Minimum Schedule Profile in Window Configuration window of FIG. 18 is activated by selecting the maximum schedule profile in window plug-in from the menu of FIG. 14. This window is used to configure a work rule based on the maximum schedule profiles in window plug-in.

This rule requires a schedule profile, a positive integer, and a definition for the time window. The time window may be described in one of two ways. First, when moving window is selected, all contiguous spans of the specified number of days that include the evaluating schedule are tested against the minimum occurrences of the given profile. Second, when fiscal period is selected, the entire fiscal period that contains the evaluating schedule is tested against the minimum occurrences of the given profile.

The rule will generate localized configuration of the form:
Schedule profile=Day Off(Day off)
Minimum schedules in window=5
Fiscal period=BIWEEK(bi-weekly)

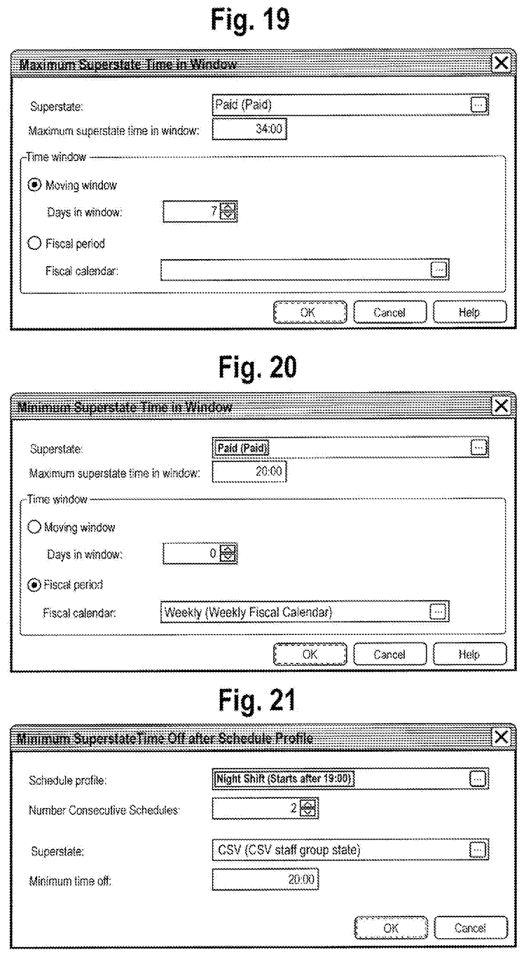

The Maximum Superstate Time in Window window of FIG. 19 is activated by selecting the maximum superstate time in window plug-in shown in the menu of FIG. 14. This window is used to configure a work rule based on the maximum working hours in window plug-in.

This rule requires a superstate, a non-negative duration, and a definition for the time window. The time window may be described in one of two ways. First, when moving window is selected, all contiguous spans of the specified number of days are tested against the maximum superstate hours. Second, when fiscal period is selected, the entire fiscal period that contains the evaluating schedule is tested against the maximum superstate hours.

The rule will generate localized configuration of the form:
Superstate=Hazard Work(Used for Work Rule)
Maximum Working Hours in Window=5:00
Days in Window=7

The Minimum Superstate Time in Window window of FIG. 20 is activated by selecting the corresponding plug-in from the menu of FIG. 14. This window is used to configure a work rule based on the minimum working hours in window plug-in.

This rule of this window requires a superstate, a positive duration, and a definition for the time window. The time window may be described in one of two ways. First, when a moving window is selected, all contiguous spans of the specified number of days are tested against the minimum superstate hours. Second, when fiscal period is selected, the entire fiscal period that contains the evaluating schedule is tested against the minimum superstate hours.

The rule will generate localized configuration of the form:
Superstate=Training(Training)
Minimum duration=1:00
Fiscal period=Biweekly(Two week calendar)

The Minimum Superstate Time Off after Schedule Profile window of FIG. 21 is activated by selecting the corresponding plug-in from the menu of FIG. 14. This window is used to configure a work rule based on the minimum time off after a schedule profile plug-in.

The rule of this window requires a schedule profile, a number of consecutive occurrences, a superstate, and a duration.

The rule will generate a localized configuration of the form:
Schedule profile=Night Shift(Starts after 19:00)
Number Consecutive Schedules=2
Superstate=CSV(CSV staff group state)
Minimum Time Off=20:00

The Work Rule Set Module window of FIG. 22 is activated by selecting the corresponding softkey from the menu of FIG. 3. Work rules sets are managed in the Work Rule Set module located within the rules engine 52.

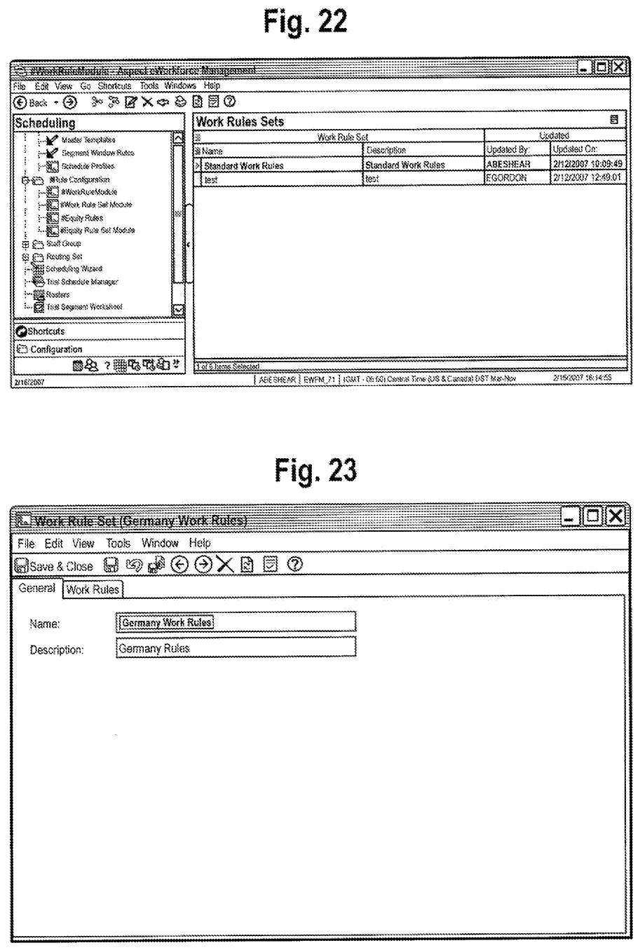

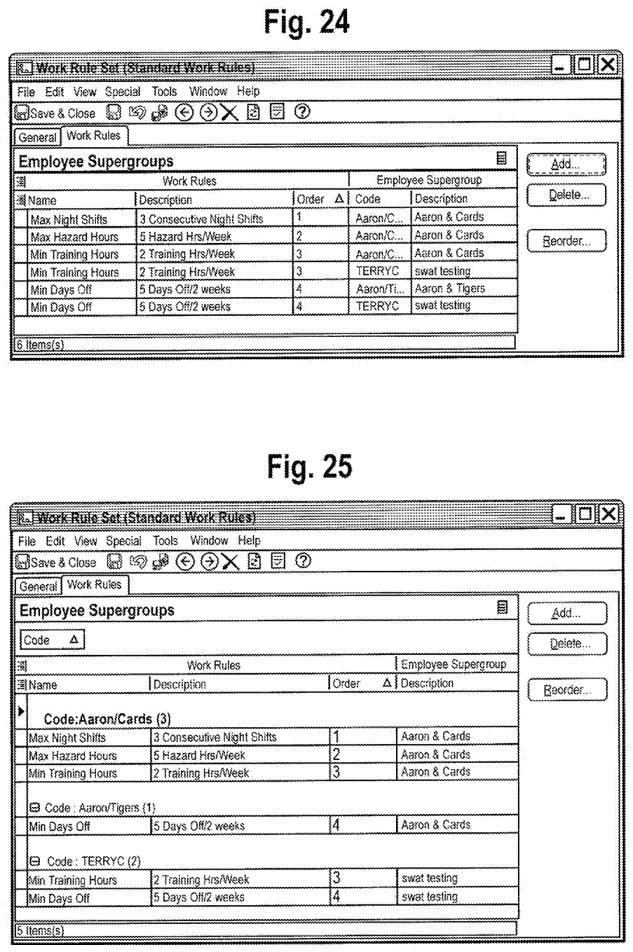

The Work Rule Set Editor window of FIG. 23 is activated by selecting the corresponding work rule from the menu of FIG. 22. This may be done through the work rules window of FIG. 24 accessed by activating the WORK RULES softkey in FIG. 23.

By using the grouping capabilities of the system 10, the user will be able to group by employee supergroup and easily view the work rules assigned to each employee supergroup. The user may perform this ordering by selecting a rule (e.g., Max Night Shifts) and the Employee Supergroup softkey to view the Employee Supergroups window of FIG. 25.

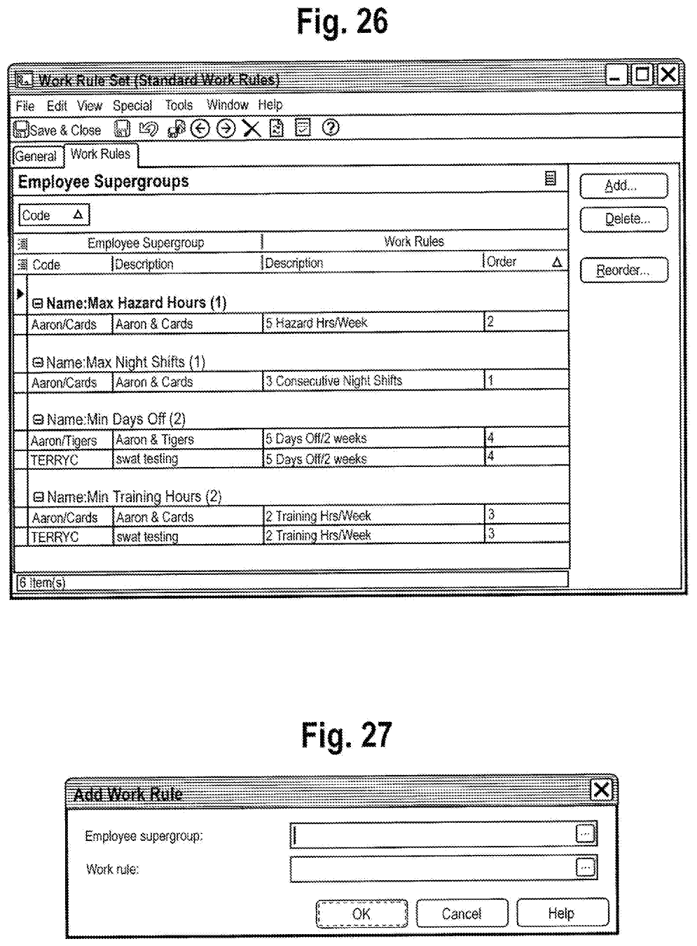

Also, by grouping by work rules, the user will be able to easily view the employee supergroups assigned to each work rules. The user can do this by activating the Employee Supergroup softkey on FIG. 25 for display of the employee supergroup window of FIG. 26.

On this window, the user will be able to add and remove employee supergroup/work rule associations from the set as well as define the order of the work rules.

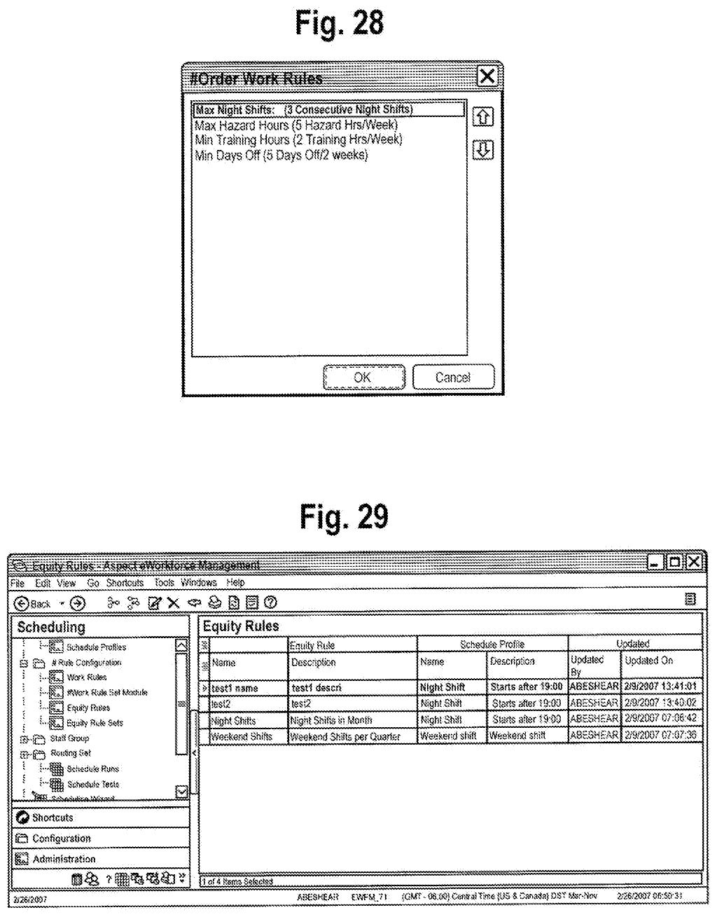

When the user clicks the Add Button on FIG. 26, he/she will be presented with a rule addition window similar to that shown in FIG. 27. On this window, the user will be able to select an employee supergroup and a work rule to add. If the employee supergroup and work rule association is already in the list, then the user will be presented with a message.

There is an order to the work rules within the work rule set; this order is independent of the employee supergroups so that there is not a conflict if an employee happens to be in two employee supergroups. To reorder the work rules, the user clicks the REORDER button on the window of FIG. 26 and is presented with the reordered window of FIG. 28. This dialog allows work rules to be moved up and down in priority order.

Equity rules are managed in the Equity Rule module located within the equity rules engine 56 within the scheduling system. In this case, the user may select the EQUITY RULES softkey of FIG. 3 and be presented with the equity rules window of FIG. 29.

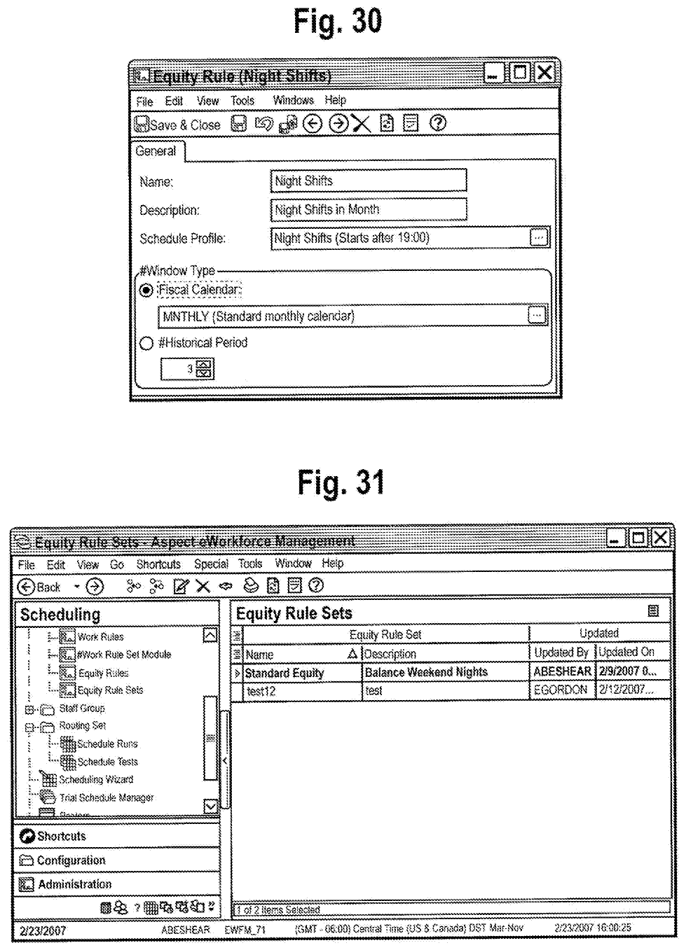

The user may access an equity rule editor window of FIG. 30 by selecting Night Shifts from the menu of FIG. 29. By selecting the Add or Edit command, the user is then able to create or modify an equity rule.

An equity rule requires a name, description, schedule profile, and a definition for the time window. The time window may be described in one of two ways. First, when moving window is selected, schedules in all contiguous spans of the specified number of days are evaluated against the schedule profile. Second, when fiscal period is selected, schedules in each fiscal period of the selected fiscal calendar are evaluated against the schedule profile.

A user may also access an equity rule set window of FIG. 31 by activating the corresponding softkey of FIG. 3. Like work rules, equity rules are collected into sets called equity rule sets. Equity rules sets are managed in the Equity Rule Sets module located within the equity engine 56.

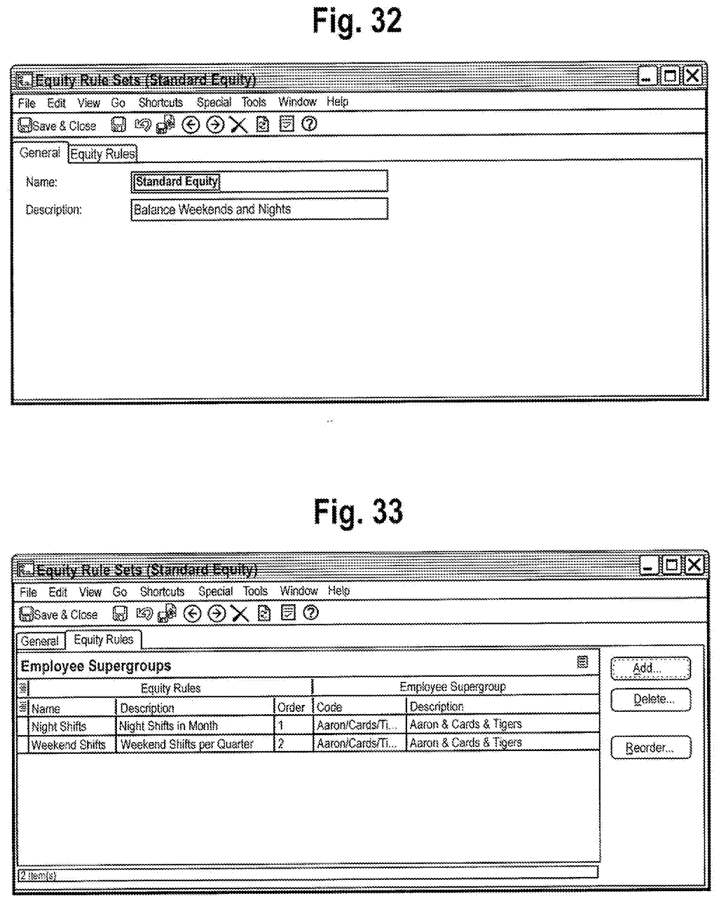

Once the user accesses the equity rule set window of FIG. 31, the user may further access an equity rule set editor module through the window of FIG. 32 by selecting the Add or Edit command on an intermediate window. Through this window, the user is able to create or modify an equity rule.

The user may access a particular equity rule set window (FIG. 33) by activating the EQUITY RULES softkey on FIG. 32. In this case, the equity rules are ordered and associated with employee supergroups on the equity rule tab.

To improve the equity score for employees, the flow of scheduling followed by the scheduling system 10 has been modified so that before other schedules are created, employees with low Equity Scores will have schedules created that improve their Equity Score. The user will also have the option to select an equity rule set on the Equity/Work Rules tab.

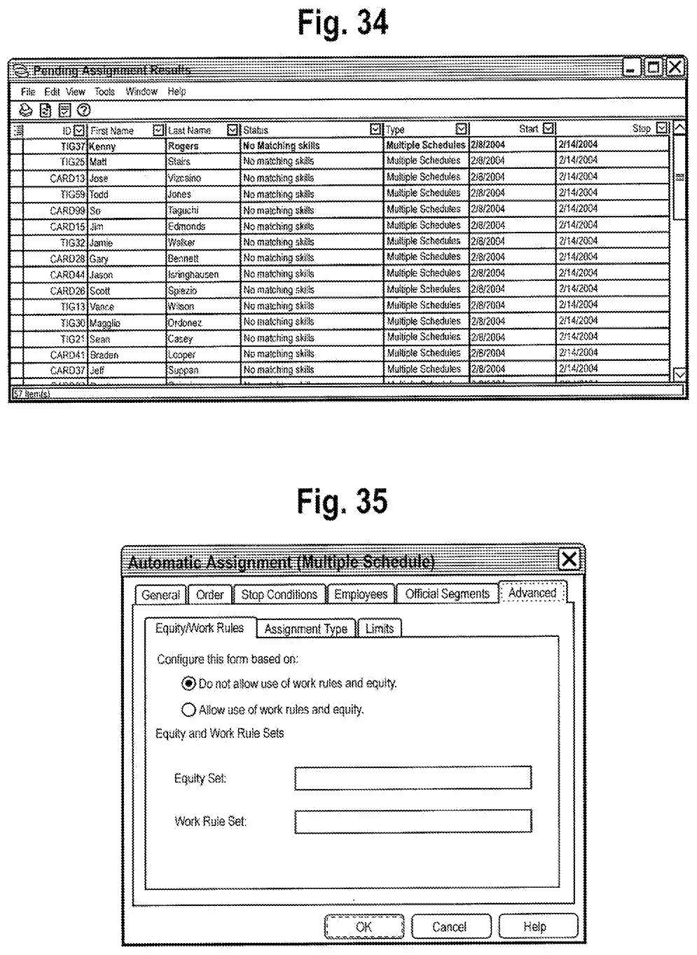

Assignment of agents 20, 22 to schedules 38, 40 may be accomplished manually by a user entering the names of agents into schedules 38, 40 or, alternatively, the scheduling processor 36 may assign agents to schedules 38, 40 automatically. At the end of the scheduling run, the user is presented with the results for each employee, as well as what assignments were made. The schedules 38, 40 may be accessed on the schedules window of FIG. 34 via the corresponding softkey of FIG. 3.

Automatic Assignment is performed by choosing the menu option in the assignment window of FIG. 35. The user selects the schedule he wants to assign and then selects the assignment type, either multi-schedule assignment, single schedule assignment, or personal account assignment.

The runtime window for automatic assignment by the scheduling processor 38 allows the user to specify the work rule set and equity rule set to be used for the assignment run. It also has additional stopping options available that will stop the assignment process if there are work rule violations or if there is not sufficient improvement in the equity scores for employees.

The assignment results includes details about the schedules that were assigned as well as information (if applicable) about why more schedules were not assigned to the employee. Additionally, the assignment also gives an indication as to how the equity score for employees was affected by the assignment run.

The multi-schedule assignment window of FIG. 35 considers single day schedules and assigns multiple schedules (if possible) to an employee. The use may enter an identifier of a work rule or equity rule set through the appropriate window. To account for work rules, multi-schedule assignment checks the viability of schedules against a selected work rule set. In order for work rules to be checked, the user will need to specify a work rule set. Once a work rule set of equity rule set has been identified, the user may activate the assignment processor 42 to assign agents 20, 22 to the schedule 38, 40.

During use, one or more schedules 38, 40 may be created by the agent assignment processor 42. The schedules may be created adding agents one-at-a-time or multiple agents. In many cases, a number of intermediate schedules 38, 40 may be created for the same period and then compared to identify the best schedule in terms of rule compliance and equity.

In order to identify the best schedule for any time interval, work rules may be organized into sets of work rules that apply to different groups of agents 20, 22. These sets of work rules are then used as part of the schedule creation and schedule assignment processes to ensure that work rules and labor laws are not violated. However, as schedules are created and assigned to an agent, intermediate schedule assignments may not satisfy all of the work rules. For this reason, the system 10 provides guidance from the work rules toward schedules that will pass the work rules. Also because multiple work rules can be required for labor laws, the system includes provisions to combine the guidance from multiple work rules into a single result that can be used for schedule creation and assignment. The process may rely upon sets of work rules by themselves or may incorporate equity rules to further improve the result.

In order to evaluate different schedules 38, 40, the system 10 generates a score or metric for each schedule 38, 40. This score represents the probability of successfully passing the work rule if the given schedule is assigned to the employee. As potential schedules are evaluated within a calculation processor 64 and the scores for the schedules may be compared within a comparator 60, so that the schedules that are better suited to passing the work rule will be assigned to the agent.

The scores that are generated by the work rules help guide the schedule creation and assignment process towards schedules that are likely to help the work rule to eventually be satisfied and away from schedules that will likely cause the work rule to be violated. The probability value may be generated in any of a number of different methods by the scheduling processor 36. Under one method, a number of schedules may simply be created and the likelihood of passing may be determined from the number of matches between the various rules within the schedule. Alternatively, the probability may be calculated using a closed form solution. The likelihood may also be determined from a random sampling of possible scheduling assignments. Still another way of determining likelihood may be by totaling the matches and looking up the probability within a cache of possible outcomes.

Alternatively, the scheduling processor 36 returns a total number of matches for each work rule for each schedule. In order to collectively evaluate the results from multiple work rules, a geometric mean can be used to combine the results of the work rules applied to each schedule. For example, suppose that there are N rules being used and R₀. R₁, . . . , R_{N-1}, are the results (number of matches) for the work rules. The geometric mean used to combine the resulting scores (S) may be calculated using Equation (1).

$$S = {\prod }_{i = 0}^{N - 1} \sqrt[N]{{R}_{i}} \qquad ( 1 )$$

In order to develop the best schedule, all possible permutations of the schedule may be tested against a rule. The result provides a comprehensive interim score for a particular schedule as the schedule is developed (i.e., as agents are assigned to the schedule). The formula used within a probability processor 66 to determine the score is as follows where Pr is the probability that the schedule will eventually pass with regard to the applicable work rules as calculated using Equation (2).

Pᵣ=(total number of schedules that pass)/(total number of possible schedules) (2)

When the total number of unassigned days becomes large, then it can become inefficient to test all possible profile match combinations because of the computational resources required.

Given the burden of testing all possible profile match combinations, a random sampling process may be used to determine the value of Pr. For example, if work schedules were to be evaluated using only two rules, then any day in the schedule may have any one of four different states: (1 the day does not match either rule, (2 the match matches the first rule only, (3 the day matches the second rule only or (4 the day matches both rules.

In order to randomly sample a schedule, each unassigned day is randomly assigned by a random state generator 68 to one of the four states. Once each unassigned day has been assigned a specific state, the probability Pr that the schedule will eventually comply with a rule is determined. This random replacement and evaluation process is repeated for a number of times that is equal to a desired sampling size with each pass/fail result being accumulated. Sampling size may be determined as a percentage of the number of agents within the schedule. Once the desired number of samples have been evaluated, the final score Pr is calculated using the Equation (3).

Pᵣ=(total number of samples that pass)/(total number of samples taken) (3)

Using this method, schedules that have the least probability of meeting work and equity rules may be discarded at any stage of the schedule evaluation process. Once the schedule has been fully populated, a work rule and equity rule score may be calculated for each schedule and compared as a basis for selection of the best schedule. The best schedule could be the schedule with the highest or lowest score depending upon whether positive or negative logic is used.

A specific embodiment of method and apparatus for scheduling agents has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A system comprising:
a workforce management (WFM) server connected to a global communications network comprising a first microprocessor and a first non-volatile non-transitory memory storing first computer executable instructions for execution by the first microprocessor;
a second memory database accessible to the WFM server storing a database;
a plurality of automatic contact distribution (ACD) systems, each ACD system of the plurality of ACD systems connected to the global communications network and supporting communications between a plurality of agents and a plurality of clients via a plurality of communications networks of which the global communications network is one; and
a scheduling system in electronic communication with the WFM server comprising a second microprocessor and a second non-volatile non-transitory memory storing second computer executable instructions for execution by the second microprocessor; wherein
the first computer executable instructions when executed by the first microprocessor configure the WFM server to:
collect data regarding a plurality of first communications, each first communication being between the plurality of agents associated with the plurality of ACD systems and the plurality of clients where the communication is established at the request of a client of the plurality of clients, the agent of the plurality of agents is automatically assigned by an ACD system of the plurality of ACD systems, and the communication between the client of the plurality of clients and the agent of the plurality of agents is established via a first communications network of the plurality of communications networks;
collect additional data regarding a plurality of second communications, each second communication being between the plurality of agents associated with the plurality of ACD systems and the plurality of clients where the communication is established by an ACD system of the plurality of ACD systems, the client of the plurality of clients is assigned by the ACD system of the plurality of ACD systems, and the communication between the client of the plurality of clients and the agent of the plurality of agents is established via a second communications network of the plurality of communications networks;
store the data within the database;
store the additional data within the database;
process the data and the additional data to establish a predicted future workload for an ACD system of the plurality of ACD systems; and
transmit the predicted future workload to the scheduling system;
the second computer executable instruction when executed by the second microprocessor configure the scheduling system to:
receive the predicted future workload from the WTF server;
automatically generate a plurality of work schedules, each work schedule of the plurality of work schedules established automatically in dependence upon the predicted future workload;
assign a first subset of the plurality of agents associated with the ACD system of the plurality of ACD systems to the plurality of work schedules;
apply a set of work rules of a plurality of work rule sets to the plurality of work schedules;
discard work schedules of the plurality of work schedules that do not comply with the set of work rules of the plurality of work rules;
amend a remaining subset of the plurality of work schedules by adding more scheduling events where the remaining subset of the plurality of work schedules are those that comply with the set of work rules of the plurality of work rules;
automatically iterate by applying the set of work rules, discarding non-compliant work schedules of the plurality of work schedules and amending the remaining subset of the plurality work schedules that comply at each iteration until a first predetermined condition is met;
generate a first output for presentation to a user when the first predetermined condition is met; and
generate a second output for presentation to the user when the first predetermined condition has not been met but a second predetermined condition has been met;
the second computer executable instructions when executed by the second microprocessor further configure the scheduling system to:
test if a single day schedule of an agent of the plurality of agents is of a particular schedule type by employing a plurality of schedule profiles; wherein
each schedule profile of the plurality of schedule profiles defines a set of constraints and a set of conditions;
each schedule profile of the plurality of schedule profiles is a reusable means of defining schedule types within a set of work rules employed by the scheduling system; and
each schedule profile of the plurality of schedule profiles is employed by the scheduling system in a first configuration with respect to a set of equity rules to determine an equity score for the agent of the plurality of agents and in a second configuration to determine whether to accept or reject a work schedule of the plurality of work schedules.

2. The method according to claim 1, wherein
either the first communications network of the plurality of communications networks or the second communications network of the plurality of communications networks is a chat room.

3. The method according to claim 1, wherein
an ACD system of the plurality of ACD systems determines a purpose of a contact initiated by a client in dependence upon a source address of the client and a destination address the client employed in initiating the contact.

4. The method according to claim 1, wherein
an ACD system of the plurality of ACD systems determines a purpose of a contact initiated by a client in dependence upon a source uniform address locator (URL) associated with the client and a destination URL the client employed in initiating the contact.

5. The method according to claim 1, wherein
the second computer executable instructions configure the scheduling system to pseudorandomly select agents within a second subset of the plurality of agents associated with the ACD system of the plurality of ACD systems; and
the second subset of the plurality of agents associated with the ACD system of the plurality of ACD systems is all agents of the plurality of agents associated with the ACD system of the plurality of ACD systems.

6. The method according to claim 1, wherein
the first predetermined condition is that a work rule is not satisfied for an agent of the modified first subset of the plurality of agents.

7. The method according to claim 1, wherein
the first predetermined condition is that no work schedule of the plurality of work schedules can be assigned to an agent of the modified first subset of the plurality of agents without violating a work rule.

8. The method according to claim 1, wherein
the second computer executable instructions further configure the scheduling system to calculate for each agent within the modified first subset of the plurality of agents an equity score in dependence upon applying an equity rule set of a plurality of equity rules sets;
the first predetermined condition is that no improvement in equity occurs for a predetermined subset of the modified first subset of the plurality of agents;
the predetermined subset of the modified first subset of the plurality of agents are those agents with low equity scores.

9. The method according to claim 1, wherein
the second computer executable instructions further configure the scheduling system to:
calculate for each agent within the modified first subset of the plurality of agents an equity score in dependence upon applying an equity rule set of a plurality of equity rules sets for each iteration; and
provide a user associated with the scheduling system with the ability to modify a flow of a preference based scheduling process employing the set of work rules so that prior to another iteration those agents with low equity scores have schedules created that improve their equity scores.

10. The method according to claim 1, wherein
the second computer executable instructions further configure the scheduling system to:
calculate for each agent within the modified first subset of the plurality of agents an equity score in dependence upon applying an equity rule set of a plurality of equity rules sets for each iteration;
provide a user associated with the scheduling system with the ability to select the equity rule set of the plurality of equity rule sets between iterations;
provide the user associated with the scheduling system with the ability to modify a flow of a preference based scheduling process employing the set of work rules so that prior to another iteration those agents with low equity scores have schedules created that improve their equity scores.

11. The method according to claim 1, wherein
the second computer executable instructions further configure the scheduling system to:
allow establishment of a work schedule of the plurality of work schedules that will cause a work rule to not be satisfied; and
prevent assignment of a work schedule of the plurality of work schedules that will establish a work rule violation.

12. The method according to claim 1, wherein
the second computer executable instructions further configure the scheduling system to:
not assign an agent of the plurality of agents if all work schedules of the plurality of work schedules cause a violation of a work rule of the set of work rules.

13. The method according to claim 1, wherein
the work rules within each set of work rules of the plurality of work rule sets have an order; and
the order is independent of any agent supergroup of a plurality of agent supergroups such that no conflict if an agent is within two more agent supergroups of the plurality of agent supergroups.

14. The method according to claim 1, wherein
the second computer executable instructions further configure the scheduling system to:
test if a single day schedule of an agent of the plurality of agents is of a particular schedule type by employing a plurality of schedule profiles and establishing whether a match exists; wherein
each schedule profile of the plurality of schedule profiles comprises a plurality of attributes; and
a match is determined only if all attributes of a schedule profile of the plurality of schedule profiles match the work schedule of the plurality of work schedules.

15. The method according to claim 1, wherein
the second computer executable instructions further configure the scheduling system to:
establish a schedule profile of a plurality of schedule profiles in dependence upon inputs provided by a user of the scheduling system;
evaluate the of the plurality of work schedules to determine matches; and
generate a score for each work schedule of the plurality of work schedules in dependence upon evaluating matched schedule profiles of the plurality of work schedules and unmatched schedule profiles of the plurality of work schedules; and
the score is a probability the work schedule of the plurality of work schedules does not violate a work rule.

16. The method according to claim 1, wherein
the second computer executable instructions further configure the scheduling system to:
establish a schedule profile of a plurality of schedule profiles in dependence upon inputs provided by a user of the scheduling system;
evaluate the of the plurality of work schedules to determine matches; and
generate a score for each work schedule of the plurality of work schedules in dependence upon evaluating matched schedule profiles of the plurality of work schedules and unmatched schedule profiles of the plurality of work schedules; and
the score is a probability the work schedule of the plurality of work schedules does not violate a work rule established by random sampling of possible schedule assignments.

17. The method according to claim 1, wherein
the second computer executable instructions further configure the scheduling system to:
establish a schedule profile of a plurality of schedule profiles in dependence upon inputs provided by a user of the scheduling system;
evaluate the of the plurality of work schedules to determine matches; and
generate a score for each work schedule of the plurality of work schedules in dependence upon evaluating matched schedule profiles of the plurality of work schedules and unmatched schedule profiles of the plurality of work schedules; and
the score is a probability the work schedule of the plurality of work schedules does not violate a work rule established by totalling the matches and looking up the probability within a cache of possible outcomes.

18. The method according to claim 1, wherein
a first work rule of the plurality of work rules prohibits an event described by a schedule profile occurring above a first predetermined threshold within a predefined window of time;
a second work rule of the plurality of work rules prohibits an event described by a schedule profile occurring below a second predetermined threshold within a predefined window of time; and
the predefined window is a rolling window or a fixed window.

19. The method according to claim 1, wherein
each work rule of the plurality of work rules is established by a work rule plug-in of a plurality of work rule plug-ins; and
the plurality of work rule plug-ins are installed within each agent station of a plurality of agent stations allowing an agent of the plurality of agents associated with the agent station of a plurality of agent stations to verify the validity of their work schedule relating to a set of work rules of the plurality of sets of work rules.

20. The method according to claim 1, wherein
each work rule of the plurality of work rules is established by a work rule plug-in of a plurality of work rule plug-ins; and
the plurality of work rule plug-ins are installed within each agent station of a plurality of agent stations allowing an agent of the plurality of agents associated with the agent station of a plurality of agent stations to verify an equitable distribution of certain of types of schedules within their work schedule

21. The system according to claim 1, wherein
a scheduling event is a schedule agent of the plurality of agents.
